(19) United States
(12) Patent Application Publication
(10) Pub. No.: US 2024/0043340 A1
(43) Pub. Date: Feb. 8, 2024

(54) HAPTIC ARTICLES AND APPLICATIONS USING SINTERED ARTICLES PREPARED FROM MOLDED GEL COMPOSITIONS

(71) Applicant: 3M INNOVATIVE PROPERTIES COMPANY, St. Paul, MN (US)

(72) Inventors: Jonathan T. Kahl, Woodbury, MN (US); Paul A. Kendrick, North Oaks, MN (US); Nathaniel D. Anderson, St. Paul, MN (US); Orlin B. Knudson, Vadnais Heights, MN (US); Jason L. Aveldson, Prior Lake, MN (US); Kathleen M. Humpal, Stillwater, MN (US); Eric Cybulski, Woodbury, MN (US)

(21) Appl. No.: 18/021,392

(22) PCT Filed: Aug. 12, 2021
(86) PCT No.: PCT/IB2021/057447

§ 371 Date: Feb. 15, 2023

Related U.S. Application Data
(60) Provisional application No. 62/706,600, filed on Aug. 27, 2020.

(51) Int. Cl. C04B 35/486; C04B 35/624; C04B 35/64; C04B 35/634; C04B 35/626; B06B 1/06; H02N 2/04

(52) U.S. Cl. CPC C04B 35/486; C04B 35/624; C04B 35/64; C04B 35/634; C04B 35/6269; B06B 1/0644; H02N 2/04; C04B 2235/3246; C04B 2235/5454

(57) ABSTRACT

Haptic articles, methods of making the haptic articles, and applications using sintered articles prepared from molded gel compositions are provided. The haptic articles include a shaped zirconia ceramic plate and a piezoelectric actuator attached to the shaped zirconia ceramic plate to vibrate the shaped zirconia ceramic plate at an ultrasonic frequency.

### BACKGROUND

Research on ultrasonically driven variable friction surfaces have been conducted, where vibrating a substrate at amplitudes in the micrometer range at ultrasonic frequencies could make a rough surface feel smoother. This may be due to a “squeeze air film” effect, where a thin film of air is trapped between an input unit (e.g., a fingertip) and the surface that leads to less contact therebetween, which results a lower friction. Later work applied this principle to larger surfaces such as glass over an LCD screen.

### SUMMARY

The present disclosure provides haptic articles, methods of making the haptic articles, and applications using sintered articles prepared from molded gel compositions.

In one aspect, the present disclosure describes a haptic device including a shaped zirconia ceramic plate including a plate body and a working surface thereof; and a piezoelectric actuator attached to the shaped zirconia ceramic plate, configured to generate a standing wave on the working surface of the shaped zirconia ceramic plate at an ultrasonic frequency greater than 20 kHz. In some cases, the shaped zirconia ceramic plate is a product of drying and sintering a shaped gel article. The shaped gel article includes a polymerized product of a reaction mixture, where the reaction mixture is positioned within a mold cavity during polymerization and wherein the shaped gel article retains both a size and shape identical to the mold cavity (except in a region where the mold cavity was overfilled) when removed from the mold cavity.

In another aspect, the present disclosure describes a method of making a haptic device. The method includes providing a reaction mixture within a mold cavity, the reaction mixture comprising 20 to 60 weight percent zirconia-based particles based on a total weight of the reaction mixture; polymerizing the reaction mixture to form a shaped gel plate within the mold cavity and in contact with a surface of the mold cavity; removing the shaped gel plate from the mold cavity, wherein the shaped gel plate retains a size and shape identical to the mold cavity; forming a dried shaped gel plate by removing the solvent medium; heating the dried shaped gel plate to form a shaped zirconia ceramic plate; and providing a piezoelectric actuator attached to the shaped zirconia ceramic plate, configured to generate a standing wave on the working surface of the shaped zirconia ceramic plate at an ultrasonic frequency greater than 20 kHz.

Various unexpected results and advantages are obtained in exemplary embodiments of the disclosure. Advantages of exemplary embodiments of the present disclosure include, for example, the haptic articles including a shaped zirconia ceramic plate exhibiting a high efficiency of converting power to Z-axis displacement as compared to conventional glass resonators. Furthermore, the shaped zirconia ceramic plate can be prepared from the correspondingly shaped gel articles which can have complex and fine features that can be retained in the sintered article.

Various aspects and advantages of exemplary embodiments of the disclosure have been summarized. The above Summary is not intended to describe each illustrated embodiment or every implementation of the present certain exemplary embodiments of the present disclosure. The Drawings and the Detailed Description that follow more particularly exemplify certain preferred embodiments using the principles disclosed herein.

### BRIEF DESCRIPTION OF THE DRAWINGS

The disclosure may be more completely understood in consideration of the following detailed description of various embodiments of the disclosure in connection with the accompanying figures, in which:

FIG. 1 is a schematic diagram of a haptic device including a shaped zirconia ceramic plate, according to one embodiment.

FIG. 2 is a perspective view of a shaped zirconia ceramic plate, according to one embodiment.

FIG. 3 is a perspective view of a shaped zirconia ceramic plate, according to another embodiment.

FIG. 4 is a plan view of a shaped zirconia ceramic plate, according to another embodiment.

FIG. 5 is a side perspective view of a shaped zirconia ceramic plate, according to another embodiment.

FIG. 6 is a side perspective view of the shaped zirconia ceramic plate, according to another embodiment.

FIG. 7 is a flow diagram of a process to make a shaped zirconia ceramic plate, according to one embodiment.

In the drawings, like reference numerals indicate like elements. While the above-identified drawing, which may not be drawn to scale, sets forth various embodiments of the present disclosure, other embodiments are also contemplated, as noted in the Detailed Description. In all cases, this disclosure describes the presently disclosed disclosure by way of representation of exemplary embodiments and not by express limitations. It should be understood that numerous other modifications and embodiments can be devised by those skilled in the art, which fall within the scope and spirit of this disclosure.

### DETAILED DESCRIPTION

For the following Glossary of defined terms, these definitions shall be applied for the entire application, unless a different definition is provided in the claims or elsewhere in the specification.

### Glossary

Certain terms are used throughout the description and the claims that, while for the most part are well known, may require some explanation. It should be understood that:

As used herein, the term “zirconia” refers to various stoichiometric formulas for zirconium oxide. The most typical stoichiometric formula is ZrO₂, which is generally referred to as either zirconium oxide or zirconium dioxide.

As used herein, the term “zirconia-based” means that the majority of the material is zirconia. For example, at least 70 mole percent, at least 75 mole percent, at least 80 mole percent, at least 85 mole percent, at least 90 mole percent, at least 95 mole percent, or at least 98 mole percent of the material is zirconia. The zirconia is often doped with other inorganic oxides such as, for example, a lanthanide element oxide and/or yttrium oxide.

As used herein, the term “inorganic oxide” includes, but is not limited to, oxides of various inorganic elements such as, for example, zirconium oxide, yttrium oxide, lanthanide element oxide, aluminum oxide, calcium oxide, and magnesium oxide.

As used herein, the term “lanthanide element” refers to an element in the lanthanide series of the periodic table of elements. The lanthanide series can have an atomic number 57 (for lanthanum) to 71 (for lutetium). Elements included in this series are lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu). As used herein, the term “rare earth” refers to an element that is scandium (Sc), yttrium (Y), or a lanthanide element.

As used herein, the term “in the range” includes the endpoints of the range and all numbers between the endpoints. For example, in the range of 1 to 10 includes the numbers 1, 10, and all numbers between 1 and 10.

As used herein, the term “associated” refers to a grouping of two or more primary particles that are aggregated and/or agglomerated. Similarly, the term “non-associated” refers to two or more primary particles that are free or substantially free from aggregation and/or agglomeration.

As used herein, the term “aggregation” refers to a strong association of two or more primary particles. For example, the primary particles may be chemically bound to one another. The breakdown of aggregates into smaller particles (e.g., primary particles) is generally difficult to achieve.

As used herein, the term “agglomeration” refers to a weak association of two or more primary particles. For example, particles may be held together by charge or polarity. The breakdown of agglomerates into smaller particles (e.g., primary particles) is less difficult than the breakdown of aggregates into smaller particles.

As used herein, the term “primary particle size” refers to the size of a non-associated single crystal zirconia particle, which is considered to be a primary particle. X-ray diffraction (XRD) is typically used to measure the primary particle size.

As used herein, the term “hydrothermal” refers to a method of heating an aqueous medium to a temperature above the normal boiling point of the aqueous medium at a pressure that is equal to or greater than the pressure required to prevent boiling of the aqueous medium.

As used herein, the term “sol” refers to a colloidal suspension of discrete particles in a liquid. The discrete particles often have an average size in a range of 1 to 100 nanometers.

As used herein, the term “gel” or “gel composition” refers to a polymerized product of a reaction mixture that is a casting sol and wherein the casting sol includes zirconia-based particles, a solvent medium, polymerizable material, and a photoinitiator.

As used herein, the term “shaped gel” refers to a gel composition that has been formed within a mold cavity, wherein the shaped gel (i.e., shaped gel article) has a shape and size determined by the mold cavity. In particular, a polymerizable reaction mixture containing zirconia-based particles can be polymerized to a gel composition within a mold cavity, wherein the gel composition (i.e., shaped gel article) retains the size and shape of the mold cavity when removed from the mold cavity.

As used herein, the term “aerogel” means a three-dimensional low density (e.g., less than 30% of theoretical density) solid. An aerogel is a porous material derived from a gel, in which the liquid component of the gel has been replaced with a gas. The solvent removal is often done under supercritical conditions. During this process the network does not substantially shrink and a highly porous, low-density material can be obtained.

As used herein, the term “xerogel” refers to a gel composition that has been further processed to remove the solvent medium by evaporation under ambient conditions or at an elevated temperature.

As used herein, the term “isotropic shrinkage” refers to shrinkage that is essentially to the same extent in the x-direction, the y-direction, and the z-direction. That is, the extent of shrinkage in one direction is within 5 percent, within 2 percent, within 1 percent, or within 0.5 percent of the shrinkage in the other two directions.

As used herein, the term “net shaped process” refers to a process of producing an initial item that is substantially close to the desired final (net) shape but probably with larger dimensions to accommodate the extent of possible isotropic shrinkage. This reduces the need for traditional and costly finishing methods such as machining or grinding.

The present disclosure provides haptic articles, methods of making the haptic articles, and applications using sintered articles prepared from molded gel compositions. The haptic articles include a shaped zirconia ceramic plate and a piezoelectric actuator attached to the shaped zirconia ceramic plate to vibrate the shaped zirconia ceramic plate at an ultrasonic frequency. The haptic devices described herein can include sintered articles prepared from gel compositions.

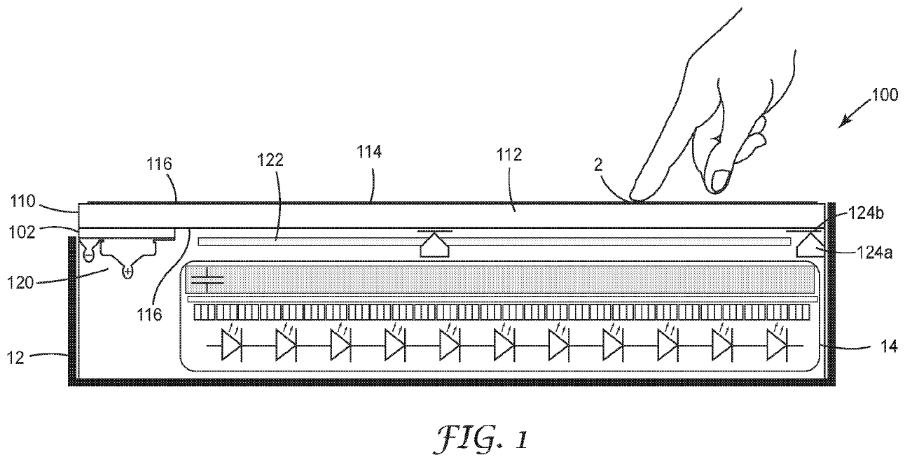

FIG. 1 is a schematic diagram of a haptic device 100 including a shaped zirconia ceramic plate 110, according to one embodiment. The shaped zirconia ceramic plate 110 including a plate body 112 and a working surface 114 thereof. A piezoelectric actuator 120 is coupled to a rear surface 116 of the shaped zirconia ceramic plate 110. The piezoelectric actuator 120 is configured to generate vibrations (e.g., a standing wave) on the working surface 114 of the shaped zirconia ceramic plate 110, for example, at an amplitude greater than 0.1 micrometers, greater than 0.2 micrometers, or greater than 0.3 micrometers, at an ultrasonic frequency greater than 20 kHz, greater than 40 kHz, or greater than 60 kHz.

In the embodiment depicted in FIG. 1, the piezoelectric actuator 120 is attached, via an epoxy 102, to an edge of the shaped zirconia ceramic plate 110 on the rear surface 116. It is to be understood that the piezoelectric actuator 120 can be coupled to the shaped zirconia ceramic plate 110 at any desired locations by any suitable mechanisms. The piezoelectric actuator 120 can be any suitable vibration actuator coupled to a shaped zirconia ceramic plate to vibrate the zirconia ceramic plate at a desired ultrasonic frequency.

In some embodiments, the piezoelectric actuator 120 may include a signal generator or amplifier that generates alternating electrical field to drive a piezoelectric transducer to vibrate. The signal generator or amplifier can use the frequency and amplitude information sent from a controller and can generate the corresponding electrical signal that varies in voltage at the frequency it received. The controller may be integrated with the signal generator or amplifier, e.g., on a printed circuit board (PCB). The controller can be a processor or a computing device including, for example, one or more general-purpose microprocessors, specially designed processors, application specific integrated circuits (ASIC), field programmable gate arrays (FPGA), a collection of discrete logic, and/or any type of processing device capable of executing the techniques described herein.

When the piezoelectric actuator 120 works, the haptic device 100 provides the vibrating working surface 114 where a friction force can decrease between a detecting object (e.g., a user's fingertip 2) and the working surface 114. This is due to a “squeeze air film” effect, where a thin film of air is trapped between the fingertip and the working surface that leads to less contact therebetween, which results a lower friction force. The variation of friction force relates to the texture of the working surface 114 and can be utilized to create variable friction surfaces.

The ultrasonic friction reduction described herein can use various forms of vibrations (e.g., a sine wave, or other complex forms) at high frequency (e.g., an ultrasonic frequency greater than 20 kHz) to drive one or more piezoelectric actuators and create a standing wave on the working surface. The frequency can be selected to match a resonant mode of the haptic device 100 in order to achieve peak displacements such as, for example, 700 nanometers or greater for a detectable decrease in friction. Unlike a low-frequency vibrotactile device, the ultrasonic frequencies (e.g., >25 kHz) applied here may not be perceived as vibration because the ultrasonic frequency vibration may be outside the response range of the mechanoreceptors of a user's skin. Instead, the working surface feels “slippery” because of the decrease of the friction force.

In some embodiments, sophisticated texture-emulation effects can be created where the resonant frequency can be used as a carrier signal and modulated at low frequencies (e.g., less than 400 Hz) that fall in the range that can be perceived as vibration.

In the present disclosure, the generated vibrations are controlled such that the surface wave on the working surface with suitable amplitude, frequency and vibration mode can generate a perceivable friction reduction effect. While not wanting to be bound by theory, it is believed that a standing wave with a half-wavelength less than a fingertip width can minimize the perceivable effect of “dead spots” (nodes) on the vibrating surface (i.e., the working surface), or else wide enough that the working surface can be on a single antinode. The minimization of “dead spots” may not be necessary to achieve a perceivable effect. In some embodiments, vibrations with a maximum displacement greater than 0.5 or 1 micrometer may be required to generate perceivable effect.

In the embodiment depicted in FIG. 1, the shaped zirconia ceramic plate 110 has its one or more edges mounted on a frame 12 in which a touch device 14 is received. The plate 110 can be provided with a low friction surface 124b that allows the plate body 112 to slide or move over a structural support 124a in the frame 12 supporting the plate body 112. Additional touch surfaces (e.g., a protective glass plate not shown in FIG. 1) can be attached to the touch device 14 via an adhesive 122 (e.g., an optically clear adhesive).

The shaped zirconia ceramic plate 110 further includes one or more complex features formed on the plate body 112 as a one-piece structure. The term “one-piece structure” means that the complex features are formed along with the shaped zirconia ceramic plate as an integral structure without adding materials to or decreasing materials from the plate to form the features. The complex features may include, for example, one or more slots, one or more grooves, one or more tabs, one or more holes, one or more bosses, one or more sockets, and the combinations thereof.

The shaped zirconia ceramic plate can be in various shapes or geometry structures such as, for example, a flat structure, a curved structure, a contoured structure, etc. The size of the plate can vary depending on various applications. In some embodiments, the various shapes can have an in-plane (e.g., XY plane in a Cartesian coordinate system) dimension in the range, for example, 1.0 mm to 10 cm, and a thickness (e.g., a dimension in the Z axis of the Cartesian coordinate system) in the range, for example, 10 micrometers to 1 mm. In some embodiments, the plate may be made from a sintered article by processes to be described further below. Sintered articles with any desired size and shape can be prepared. The longest dimension can be up to 1 centimeter, up to 2 centimeters, up to 5 centimeters, or up to 10 centimeters or even longer. The longest dimension can be at least 1 centimeter, at least 2 centimeters, at least 5 centimeters, at least 10 centimeters, at least 20 centimeters, at least 50 centimeters, or at least 100 centimeters.

The complex features can have very fine geometries. The maximum dimension (e.g., a depth, a width, a length, a diameter, etc.) of the fine geometries can be, for example, no more than about 5 mm, no more than about 2 mm, no more than about 1 mm, no more than about 0.5 mm, no more than about 0.1 mm, no more than about 0.05 mm, or even lower. In some embodiments, the maximum dimension of the fine geometries may be, for example, less than about 1/10, 1/20, 1/50, 1/100, 1/200, 1/500, or 1/1000 of the maximum dimension of the shaped zirconia ceramic plate 110.

A shaped zirconia ceramic plate described herein may include at least 70 mole percent, at least 75 mole percent, at least 80 mole percent, at least 85 mole percent, at least 90 mole percent, at least 95 mole percent, or at least 98 mole percent of zirconia-based material. At least 80 weight percent, at least 85 weight percent, at least 90 weight percent, at least 95 weight percent, at least 98 weight percent, at least 99 weight percent or at least 99.5 weight percent of the zirconia-based material have a cubic crystalline structure, a tetragonal crystalline structure, or a combination thereof.

The shaped zirconia ceramic plates described herein can have a high density as compared to, for example, a standard glass plate such as, for example, borosilicate glass with similar dimensions provided from Swift Glass Co. (Elmira Heights, NY). Borosilicate glass may have a theoretical density of about 2.23 g/cc. Tetragonal zirconia may have a theoretical density of about 6.10 g/cc. In some embodiments, a shaped zirconia ceramic plates can have a relative density that is at least 90 percent, at least 95 percent, at least 97 percent, at least 99 percent or even higher of a theoretical density of crystalline zirconia in a cubic or tetragonal phase. The theoretical density is defined as the maximum density of crystalline zirconia in the cubic or tetragonal phase with no pores.

In some embodiments, the shaped zirconia ceramic plate can be a product of drying and sintering a shaped gel article. The shaped gel article can include a polymerized product of a reaction mixture. The reaction mixture is positioned within a mold cavity during polymerization and wherein the shaped gel article retains both a size and shape identical to the mold cavity (except in a region where the mold cavity was overfilled) when removed from the mold cavity. The reaction mixture includes:
a. 20 to 60 weight percent zirconia-based particles based on a total weight of the reaction mixture, the zirconia-based particles having an average particle size no greater than 100 nanometers and comprising at least 70 mole percent ZrO₂;
b. 30 to 75 weight percent of a solvent medium based on the total weight of the reaction mixture, the solvent medium comprising at least 60 percent of an organic solvent having a boiling point equal to at least 150° C.;
c. 2 to 30 weight percent polymerizable material based on a total weight of the reaction mixture, the polymerizable material comprising (1) a first surface modification agent having a free radical polymerizable group; and
d. a photoinitiator for a free radical polymerization reaction.

The shaped zirconia ceramic plate 110 can be provided as haptic feedback devices in various forms such as, for example, buttons, knobs, touch pads, etc. In some embodiments, one or more haptic devices described herein can be combined with another electronic device such as, for example, a touch device. The “squeeze film effect” generated by the haptic device can be exploited to add a touch feedback dimension to interactions with an electronic device. This additional dimension can add enhanced realism that could potentially improve performance.

In some applications, the (X, Y) position of a user's fingertip on the working surface 114 of the shaped zirconia ceramic plate 110 can be determined. The finger position can be tracked using various devices such as, for example, a touch sensor. The touch device or sensor can be a capacitive touch sensor using a layer of indium tin oxide (ITO) mounted below the resonating surface. The (X, Y) position of the fingertip on the plate can be fed to a controller that controls the signal generation for the piezoelectric actuator. The (X, Y) positions can be mapped onto varying amplitude and/or frequency levels of the signal generator or amplifier, in order to create the haptic illusion of varying surface features when the fingertip moves on the working surface of the shaped zirconia ceramic plate.

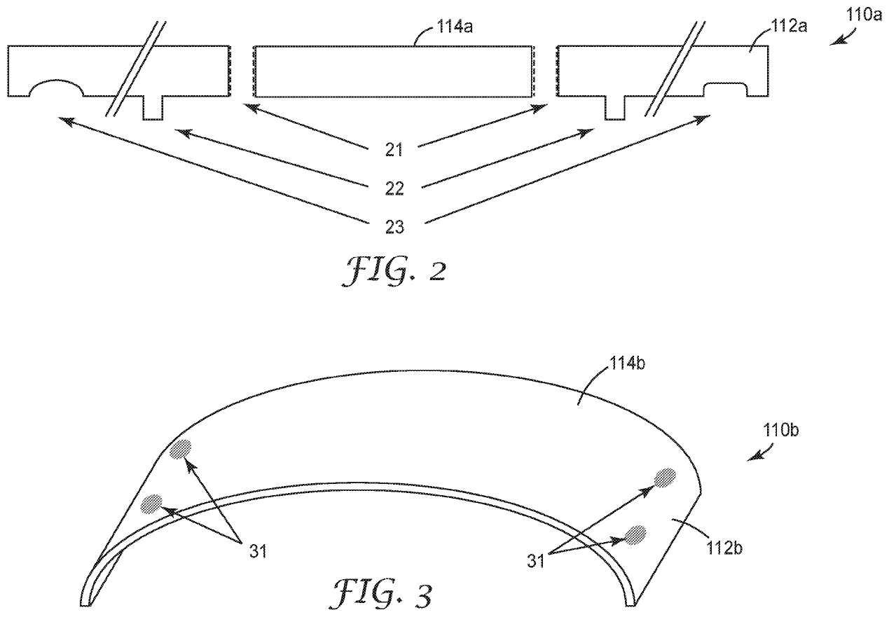

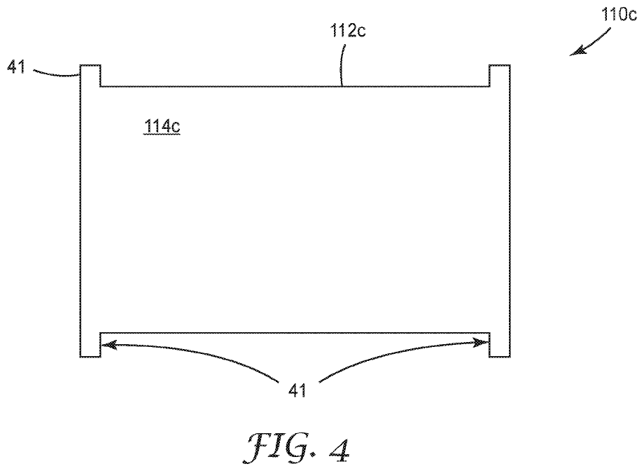

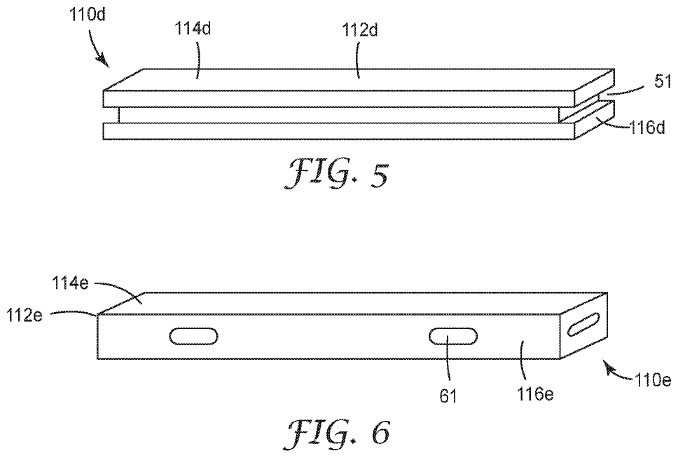

Exemplary shaped zirconia ceramic plates having various shaped structures with mounting features and/or additional features are shown in FIGS. 2-6. In the embodiment depicted in FIG. 2, the shaped zirconia ceramic plate 110a has a flat plate body 112a defining a working surface 114a thereof and one or more features such as through holes 21, bosses 22, conduits 23, etc., formed in the plate body 112a. In the embodiment depicted in FIG. 3, the shaped zirconia ceramic plate 110b has a curved plate body 112b defining a working surface 114b and one or more features such as through holes or bosses 31 formed in the plate body 112b. In the embodiment depicted in FIG. 4, the shaped zirconia ceramic plate 110c has a plate body 112c defining a working surface 114c and one or more features such as tabs 41 formed at corners of the plate body 112c. In the embodiment depicted in FIG. 5, the shaped zirconia ceramic plate 110d has a plate body 112d defining a working surface 114d and one or more slots 51 formed on the sides 116d of the plate body 112d. In the embodiment depicted in FIG. 6, the shaped zirconia ceramic plate 110e has a plate body 112e defining a working surface 114e and one or more sockets 61 formed on the sides 116e of the plate body 112e.

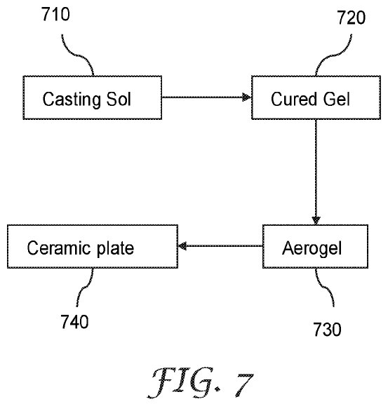

The shaped zirconia ceramic plates described herein can be produced by a process 700 illustrated in FIG. 7. The process 700 depicted in FIG. 7 provides a route to make precision net shaped ceramics from nano and/or micro particles, enabling unique geometries and properties without the high cost of machining. At 710, a reaction mixture or casting sol is prepared which contains zirconia-based particles. The reaction mixture further includes one or more polymerizable materials that have a polymerizable group that can undergo free radical polymerization (i.e., the polymerizable group is free radical polymerizable). The reaction mixture is typically placed into a mold. Thus, an article is provided at 710 that includes (a) a mold having a mold cavity and (b) a reaction mixture positioned within the mold cavity and in contact with a surface of the mold cavity. At 720, a gel composition is formed within the mold cavity by curing the reaction mixture. In some embodiments, the gel composition may include a polymerized product of the reaction mixture (i.e., casting sol). The gel composition may take on a shape defined by the mold cavity. In some embodiments, the gel composition may be formed as a shaped gel plate including a plate body and one or more mounting features formed on the plate body when in contact with the inner surfaces of the mold cavity. At 730, the shaped gel article is removed from the mold cavity and the shaped gel article is treated to remove its organic solvent. This can be referred to as drying the gel composition or the shaped gel article. A shaped gel article of any size and complexity can be dried to an aerogel article. At 740, the aerogel article is heated to remove the polymeric material or any other organic material that may be present and to build strength through densification. After organic burnout and optional soaking in an aqueous solution of ammonium hydroxide, the dried article is sintered.

### Reaction Mixture (Casting Sol)

1. Zirconia-Based Particles

The reaction mixture contains zirconia-based particles. Any suitable process can be used to form the zirconia-based particles. In particular, the zirconia-based particles have an average particle size no greater than 100 nanometers and contain at least 70 mole percent ZrO₂. The zirconia-based particles are crystalline, and the crystalline phase is predominately cubic and/or tetragonal. The zirconia-based particles are preferably non-associated, which makes them suitable for formation of high density, sintered articles. Non-associated particles lead to low viscosity and high light transmission through the reaction mixture. Additionally, non-associated particles lead to more uniform pore structures in the aerogel or xerogel and to more homogeneous sintered articles.

In many embodiments, a hydrothermal method (hydrothermal reactor system) is used to provide zirconia-based particles that are crystalline and non-associated. A feedstock for the hydrothermal reactor system is used that contains zirconia salts and other optional salts dissolved in an aqueous medium. Suitable optional salts include, for example, rare earth salts, transition metal salts, alkaline earth metal salts, and post-transition metal salts. Example rare earth salts include, for example, salts containing scandium, yttrium, lanthanum, cerium, praseodymium, neodymium, promethium, samarium, europium, gadolinium, terbium, dysprosium, holmium, erbium, thulium, ytterbium, and lutetium. Example transition metals include, but are not limited to, salts of iron, manganese, cobalt, chromium, nickel, copper, tungsten, vanadium, and hafnium. Example alkaline earth metal salts include, but are not limited to, salts of calcium and magnesium. Example post-transition metal salts include, but are not limited to, salts of aluminum, gallium, and bismuth. In many embodiments, the post-transition metal salts are salts of aluminum. In many embodiments, the optional salts are yttrium salts, lanthanum salts, calcium salts, magnesium salts, aluminum salts, or mixtures thereof. In some preferred embodiments, the optional salts are yttrium salts and lanthanum salts. The metals are typically incorporated into the zirconia-based particles rather than existing as separate particles.

The dissolved salts included in the feedstock for the hydrothermal reactor system are typically selected to have an anion that is removable during subsequent processing steps and that is non-corrosive. The dissolved salts are typically carboxylate salts such as those having a carboxylate anion with no greater than four carbon atoms such as, for example, formate, acetate, propionate, butyrate, or a combination thereof. In many embodiments, the carboxylate salts are acetate salts. That is, the feedstock often includes dissolved zirconium acetate and other optional acetate salts such as yttrium acetate and lanthanide element acetates (e.g., lanthanum acetate). The feedstock can further include the corresponding carboxylic acid of the carboxylate anion. For example, feedstocks prepared from acetate salts often contain acetic acid. The pH of the feedstock is typically acidic. For example, the pH is often up to 6, up to 5, or up to 4 and at least 2 or at least 3.

One exemplary zirconium salt is zirconium acetate salt, represented by a formula such as ZrO_{((4-n)/2)}ⁿ⁺(CH₃COO⁻)ₙ, where n is in the range from 1 to 2. The zirconium ion may be present in a variety of structures depending, for example, on the pH of the feedstock. Methods of making zirconium acetate are described, for example, in W. B. Blumenthal, “The Chemical Behavior of Zirconium,” pp. 311-338, D. Van Nostrand Company, Princeton, NJ (1958). Suitable aqueous solutions of zirconium acetate are commercially available, for example, from Magnesium Elektron, Inc. (Flemington, NJ, USA), that contain, for example, up to 17 weight percent zirconium, up to 18 weight percent zirconium, up to 20 weight percent zirconium, up to 22 weight percent zirconium, up to 24 weight percent zirconium, up to 26 weight percent zirconium, or up to 28 weight percent zirconium, based on the total weight of the solution.

The feedstock is often selected to avoid or minimize the use of anions other than the carboxylate anion. That is, the feedstock is selected to avoid the use of or to minimize the use of halide salts, oxyhalide salts, sulfate salts, nitrate salts, or oxynitrate salts. Halide and nitrate anions tend to result in the formation of zirconia-based particles that are predominately of a monoclinic phase rather than the more desirable tetragonal or cubic phases. Because the optional salts are used in relatively low amounts compared to the amount of the zirconium salt, the optional salts can have anions that are not carboxylates. In many embodiments, it is preferable that all salts added to the feedstock are acetate salts.

The amount of the various salts dissolved in the feedstock can be readily determined based on the percent solids selected for the feedstock and the desired composition of the zirconia-based particles. Typically, the feedstock is a solution and does not contain dispersed or suspended solids. For example, seed particles are not present in the feedstock. The feedstock usually contains greater than 5 weight percent solids and these solids are typically dissolved. The “weight percent solids” can be calculated by drying a sample to a constant weight at 120° C. and refers to the portion of the feedstock that is not water, a water-miscible co-solvent, or another compound that can be vaporized at temperatures up to 120° C. The weight percent solids is calculated by dividing the dry weight by the wet weight and then multiplying by 100. The wet weight refers to the weight of the feedstock before drying and the dry weight refers to the weight of the sample after drying. In many embodiments, the feedstock contains at least 5 weight percent, at least 10 weight percent, at least 12 weight percent, or at least 15 weight percent solids. Some feedstocks contain up to 20 weight percent solids, up to 25 weight percent solids, or even higher than 25 weight percent solids.

Once the percent solids have been selected, the amount of each dissolved salt can be calculated based on the desired composition of the zirconia-based particles. The zirconia-based particles are at least 70 mole percent zirconium oxide. For example, the zirconia-based particles can be at least 75 mole percent, at least 80 mole percent, at least 85 mole percent, at least 90 mole percent, or at least 95 mole percent zirconium oxide. The zirconia-based particles be up to 100 mole percent zirconium oxide. For example, the zirconia-based particles can be up to 99 mole percent, up to 98 mole percent, up to 95 mole percent, up to 90 mole percent, or up to 85 mole percent zirconium oxide.

Depending on the intended use of the final sintered articles, other inorganic oxides can be included in the zirconia-based particles in addition to zirconium oxide. Up to 30 mole percent, up to 25 mole percent, up to 20 mole percent, up to 10 mole percent, up to 5 mole percent, up to 2 mole percent, or up to 1 mole percent of the zirconia-based particles can be Y₂O₃, La₂O₃, Al₂O₃, CeO₂, Pr₂O₃, Nd₂O₃, Pm₂O₃, Sm₂O₃, Eu₂O₃, Gd₂O₃, Tb₂O₃, Dy₂O₃, Ho₂O₃, Er₂O₃, Tm₂O₃, Yb₂O₃, Fe₂O₃, MnO₂, Co₂O₃, Cr₂O₃, NiO, CuO, V₂O₃, Bi₂O₃, Ga₂O₃, Lu₂O₃, HfO₂, or mixtures thereof. Inorganic oxide such as Fe₂O₃, MnO₂, Co₂O₃, Cr₂O₃, NiO, CuO, Bi₂O₃, Ga₂O₃, Er₂O₃, Pr₂O₃, Eu₂O₃, Dy₂O₃, Sm₂O₃, V₂O₃, or W₂O₃ may be added, for example, to alter the color of the zirconia-based particles.

When no other inorganic oxide other than zirconium oxide is included in the zirconia-based particles, the likelihood of having some of the monoclinic crystalline phase present increases. In many uses, it may be desirable to minimize the amount of monoclinic phase because this phase is less stable than either the tetragonal or cubic phases when heated. For example, when the monoclinic phase is heated above 1200° C., it can transform to the tetragonal phase but then return to the monoclinic phase upon cooling. These transformations can be accompanied by volume expansion, which can lead to cracking or fracturing of the material. In contrast, the tetragonal and cubic phase can be heated to about 2370° C. or above without undergoing phase transformations.

In many embodiments when a rare earth oxide is included in the zirconia-based oxide, the rare earth element is yttrium or a combination of yttrium and lanthanum. The presence of yttrium or both yttrium and lanthanum can prevent the destructive transformation of the tetragonal phase or the cubic phase to the monoclinic phase during cooling from an elevated temperature such as those greater than 1200° C. The addition of yttrium or both yttrium and lanthanum can increase or maintain the physical integrity, toughness, or both of the sintered articles.

The zirconia-based particles can contain 0 to 30 weight percent yttrium oxide based on the total moles of inorganic oxide present. If yttrium oxide is added to the zirconia-based particles, it is often added in an amount equal to at least 1 mole percent, at least 2 mole percent, or at least 5 mole percent. The amount of yttrium oxide can be up to 30 mole percent, up to 25 mole percent, up to 20 mole percent, or up to 15 mole percent. For example, the amount of yttrium oxide can be in a range of 1 to 30 mole percent, 1 to 25 mole percent, 2 to 25 mole percent, 1 to 20 mole percent, 2 to 20 mole percent, 1 to 15 mole percent, 2 to 15 mole percent, 5 to 30 mole percent, 5 to 25 mole percent, 5 to 20 mole percent, or 5 to 15 mole percent. The mole percent amounts are based on the total moles of inorganic oxide in the zirconia-based particles.

The zirconia-based particles can contain 0 to 10 mole percent lanthanum oxide based on the total moles of inorganic oxide present. If lanthanum oxide is added to the zirconia-based particles, it can be used in an amount equal to at least 0.1 mole percent, at least 0.2 mole percent, or at least 0.5 mole percent. The amount of lanthanum oxide can be up to 10 mole percent, up to 5 mole percent, up to 3 mole percent, up to 2 mole percent, or up to 1 mole percent. For example, the amount of lanthanum oxide can be in a range of 0.1 to 10 mole percent, 0.1 to 5 mole percent, 0.1 to 3 mole percent, 0.1 to 2 mole percent, or 0.1 to 1 mole percent. The mole percent amounts are based on the total moles of inorganic oxide in the zirconia-based particles.

In some embodiments, the zirconia-based particles contain 70 to 100 mole percent zirconium oxide, 0 to 30 mole percent yttrium oxide, and 0 to 10 mole percent lanthanum oxide. For example, the zirconia-based particles contain 70 to 99 mole percent zirconium oxide, 1 to 30 mole percent yttrium oxide, and 0 to 10 mole percent lanthanum oxide. In other examples, the zirconia-based particles contain 75 to 99 mole percent zirconium oxide, 1 to 25 mole percent yttrium oxide, and 0 to 5 mole percent lanthanum oxide or 80 to 99 mole percent zirconium oxide, 1 to 20 mole percent yttrium oxide, and 0 to 5 mole percent lanthanum oxide or 85 to 99 mole percent zirconium oxide, 1 to 15 mole percent yttrium oxide, and 0 to 5 mole percent lanthanum oxide. In still other embodiments, the zirconia-based particles contain 85 to 95 mole percent zirconium oxide, 5 to 15 mole percent yttrium oxide, and 0 to 5 mole percent (e.g., 0.1 to 5 mole percent or 0.1 to 2 mole percent) lanthanum oxide. The mole percent amounts are based on the total moles of inorganic oxide in the zirconia-based particles.

Other inorganic oxides can be used in combination with a rare earth element or in place of a rare earth element. For example, calcium oxide, magnesium oxide, or a mixture thereof can be added in an amount in a range of 0 to 30 mole percent based on the total moles of inorganic oxide present. The presence of these inorganic oxides tends to decrease the amount of monoclinic phase formed. If calcium oxide and/or magnesium oxide is added to the zirconia-based particles, the total amount added is often at least 1 mole percent, at least 2 mole percent, or at least 5 mole percent. The amount of calcium oxide, magnesium oxide, or a mixture thereof can be up to 30 mole percent, up to 25 mole percent, up to 20 mole percent, or up to 15 mole percent. For example, the amount can be in a range of 1 to 30 mole percent, 1 to 25 mole percent, 2 to 25 mole percent, 1 to 20 mole percent, 2 to 20 mole percent, 1 to 15 mole percent, 2 to 15 mole percent, 5 to 30 mole percent, 5 to 25 mole percent, 5 to 20 mole percent, or 5 to 15 mole percent. The mole percent amounts are based on the total moles of inorganic oxide in the zirconia-based particles.

Further, aluminum oxide can be included in an amount in a range of 0 to less than 1 mole percent based on a total moles of inorganic oxides in the zirconia-based particles. Some example zirconia-based particles contain 0 to 0.5 mole percent, 0 to 0.2 mole percent, or 0 to 0.1 mole percent of these inorganic oxides.

The liquid medium of the feedstock for the hydrothermal reactor is typically predominantly water (i.e., the liquid medium is an aqueous-based medium). This water is preferably deionized to minimize the introduction of other metal species such as alkali metal ions, alkaline earth ions, or both into the feedstock. Water-miscible organic co-solvents can be included in the solvent medium phase in amounts up to 20 weight percent based on the weight of the solvent medium phase. Suitable co-solvents include, but are not limited to, 1-methoxy-2-propanol, ethanol, isopropanol, ethylene glycol, N,N-dimethylacetamide, and N-methyl pyrrolidone. In most embodiments, no organic solvents are added to the aqueous-based medium.

When subjected to hydrothermal treatment, the various dissolved salts in the feedstock undergo hydrolysis and condensation reactions to form the zirconia-based particles. These reactions are often accompanied with the release of an acidic byproduct. That is, the byproduct is often one or more carboxylic acids corresponding to the zirconium carboxylate salt plus any other carboxylate salt in the feedstock. For example, if the salts are acetate salts, acetic acid is formed as a byproduct of the hydrothermal reaction.

Any suitable hydrothermal reactor system can be used for the preparation of the zirconia-based particles. The reactor can be a batch or continuous reactor. The heating times are typically shorter and the temperatures are typically higher in a continuous hydrothermal reactor compared to a batch hydrothermal reactor. The time of the hydrothermal treatments can be varied depending on the type of reactor, the temperature of the reactor, and the concentration of the feedstock. The pressure in the reactor can be autogeneous (i.e., the vapor pressure of water at the temperature of the reactor), can be hydraulic (i.e., the pressure caused by the pumping of a fluid against a restriction), or can result from the addition of an inert gas such as nitrogen or argon. Suitable batch hydrothermal reactors are available, for example, from Parr Instruments Co. (Moline, IL, USA). Some suitable continuous hydrothermal reactors are described, for example, in U.S. Pat. No. 5,453,262 (Dawson et al.) and U.S. Pat. No. 5,652,192 (Matson et al.); Adschiri et al., J. Am. Ceram. Soc., 75, 1019-1022 (1992); and Dawson, Ceramic Bulletin, 67 (10), 1673-1678 (1988).

If a batch reactor is used to form zirconia-based particles, the temperature is often in the range of 160° C. to 275° C., in the range of 160° C. to 250° C., in the range of 170° C. to 250° C., in the range of 175° C. to 250° C., in the range of 200° C. to 250° C., in the range of 175° C. to 225° C., in the range of 180° C. to 220° C., in the range of 180° C. to 215° C., or in the range of 190° C. to 210° C. The feedstock is typically placed in the batch reactor at room temperature. The feedstock within the batch reactor is heated to the designated temperature and held at that temperature for at least 30 minutes, at least 1 hour, at least 2 hours, or at least 4 hours. The temperature can be held up to 24 hours, up to 20 hours, up to 16 hours, or up to 8 hours. For example, the temperature can be held in the range of 0.5 to 24 hours, in the range of 1 to 18 hours, in the range of 1 to 12 hours, or in the range of 1 to 8 hours. Any size batch reactor can be used. For example, the volume of the batch reactor can be in a range of several milliliters to several liters or more.

In many embodiments, the feedstock is passed through a continuous hydrothermal reactor. As used herein, the term “continuous” with reference to the hydrothermal reactor system means that the feedstock is continuously introduced, and an effluent is continuously removed from the heated zone. The introduction of feedstock and the removal of the effluent typically occur at different locations of the reactor. The continuous introduction and removal can be constant or pulsed.

In many embodiments, the continuous hydrothermal reactor system contains a tubular reactor. As used herein, the term “tubular reactor” refers to the portion of the continuous hydrothermal reactor system that is heated (i.e., the heated zone). The shape of the tubular reactor is often selected based on the desired length of the tubular reactor and the method used to heat the tubular reactor. For example, the tubular reactor can be straight, U-shaped, or coiled. The interior potion of the tubular reactor can be empty or can contain baffles, balls, or other known mixing means. An example hydrothermal reactor system having a tubular reactor is described in PCT Patent Application Publication WO 2011/082031 (Kolb et al.).

In some embodiments, the tubular reactor has an interior surface that contains a fluorinated polymeric material. This fluorinated polymeric material can include, for example, a fluorinated polyolefin. In some embodiments, the polymeric material is polytetrafluoroethylene (PTFE) such as that available under the trade designation “TEFLON” from DuPont, Wilmington, DE, USA. Some tubular reactors have a PTFE hose within a metal housing such as a braided stainless steel housing. The carboxylic acid that may be present in the feedstock does not leach metals from such tubular reactors.

The dimensions of the tubular reactor can be varied and, in conjunction with the flow rate of the feedstock, can be selected to provide suitable residence times for the reactants within the tubular reactor. Any suitable length tubular reactor can be used provided that the residence time and temperature are sufficient to convert the zirconium in the feedstock to zirconia-based particles. The tubular reactor often has a length of at least 0.5 meter, at least 1 meter, at least 2 meters, at least 5 meters, at least 10 meters, at least 15 meters, at least 20 meters, at least 30 meters, at least 40 meters, or at least 50 meters. The length of the tubular reactor in some embodiments is less than 500 meters, less than 400 meters, less than 300 meters, less than 200 meters, less than 100 meters, less than 80 meters, less than 60 meters, less than 40 meters, or less than 20 meters.

Tubular reactors with a relatively small inner diameter are typically preferred. For example, tubular reactors having an inner diameter no greater than about 3 centimeters are often used because of the fast rate of heating of the feedstock that can be achieved with these reactors. Also, the temperature gradient across the tubular reactor is less for reactors with a smaller inner diameter compared to those with a larger inner diameter. The larger the inner diameter of the tubular reactor, the more this reactor resembles a batch reactor. However, if the inner diameter of the tubular reactor is too small, there is an increased likelihood of the reactor becoming plugged or partially plugged during operation resulting from deposition of material on the walls of the reactor. The inner diameter of the tubular reactor is often at least 0.1 centimeters, at least 0.15 centimeters, at least 0.2 centimeters, at least 0.3 centimeters, at least 0.4 centimeters, at least 0.5 centimeters, or at least 0.6 centimeters. In some embodiments, the diameter of the tubular reactor is no greater than 3 centimeters, no greater than 2.5 centimeters, no greater than 2 centimeters, no greater than 1.5 centimeters, or no greater than 1.0 centimeters. Some tubular reactors have an inner diameter in the range of 0.1 to 3.0 centimeters, in the range of 0.2 to 2.5 centimeters, in the range of 0.3 to 2 centimeters, in the range of 0.3 to 1.5 centimeters or in the range of 0.3 to 1.0 centimeters.

In a continuous hydrothermal reactor system, the temperature and the residence time are selected in conjunction with the tubular reactor dimensions to convert at least 90 mole percent of the zirconium in the feedstock to zirconia-based particles using a single hydrothermal treatment. That is, at least 90 mole percent of the dissolved zirconium in the feedstock is converted to zirconia-based particles within a single pass through the continuous hydrothermal reactor system.

Alternatively, a multiple step hydrothermal process can be used. For example, the feedstock can be subjected to a first hydrothermal treatment to form a zirconium-containing intermediate and a by-product such as a carboxylic acid. A second feedstock can be formed by removing at least a portion of the by-product of the first hydrothermal treatment from the zirconium-containing intermediate. The second feedstock can then be subjected to a second hydrothermal treatment to form a sol containing the zirconia-based particles. This process is further described in U.S. Pat. No. 7,241,437 (Davidson et al.).

If a two-step hydrothermal process is used, the percent conversion of the zirconium-containing intermediate is typically 40 to 75 mole percent. The conditions used in the first hydrothermal treatment can be adjusted to provide conversion within this range. Any suitable method can be used to remove at least part of the by-product of the first hydrothermal treatment. For example, carboxylic acids such as acetic acid can be removed by a variety of methods such as vaporization, dialysis, ion exchange, precipitation, and filtration.

When referring to a continuous hydrothermal reactor system, the term “residence time” means the average length of time that the feedstock is within the heated portion of the continuous hydrothermal reactor system. Any suitable flow rate of the feedstock through the tubular reactor can be used as long as the residence time is sufficiently long to convert the dissolved zirconium to zirconia-based particles. That is, the flow rate is often selected based on the residence time needed to convert the zirconium in the feedstock to zirconia-based particles. Higher flow rates are desirable for increasing throughput and for minimizing the deposition of materials on the walls of the tubular reactor. A higher flow rate can often be used when the length of the reactor is increased or when both the length and diameter of the reactor are increased. The flow through the tubular reactor can be either laminar or turbulent.

In some exemplary continuous hydrothermal reactors, the reactor temperature is in the range of 170° C. to 275° C., in the range of 170° C. to 250° C., in the range of 170° C. to 225° C., in the range of 180° C. to 225° C., in the range of 190° C. to 225° C., in the range of 200° C. to 225° C., or in the range of 200° C. to 220° C. If the temperature is greater than about 275° C., the pressure may be unacceptably high for some hydrothermal reactors systems. However, if the temperature is less than about 170° C., the conversion of the zirconium in the feedstock to zirconia-based particles may be less than 90 weight percent using typical residence times.

The effluent of the hydrothermal treatment (i.e., the product of the hydrothermal treatment) is a zirconia-based sol and can be referred to as the “sol effluent”. The sol effluent is a dispersion or suspension of the zirconia-based particles in the aqueous-based medium. The sol effluent contains at least 3 weight percent zirconia-based particles dispersed, suspended, or a combination thereof based on the weight of the sol. In some embodiments, the sol effluent contains at least 5 weight percent, at least 6 weight percent, at least 8 weight percent, or at least 10 weight percent zirconia-based particles based on the weight of the sol. The weight percent zirconia-based particles can be up to 16 weight percent or higher, up to 15 weight percent, up to 12 weight percent, or up to 10 weight percent.

The zirconia-based particles within the sol effluent are crystalline and have an average primary particle size no greater than 50 nanometers, no greater than 40 nanometers, no greater than 30 nanometers, no greater than 20 nanometers, no greater than 15 nanometers, or no greater than 10 nanometers. The zirconia-based particles typically have an average primary particle size that is at least 1 nanometer, at least 2 nanometers, at least 3 nanometers, at least 4 nanometers, or at least 5 nanometers.

The sol effluent usually contains non-associated zirconia-based particles. The sol effluent is typically clear or slightly cloudy. In contrast, zirconia-based sols that contain agglomerated or aggregated particles usually tend to have a milky or cloudy appearance. The sol effluent often has a high optical transmission due to the small size and non-associated form of the primary zirconia particles in the sol. High optical transmission of the sol effluent can be desirable in the preparation of transparent or translucent sintered articles. As used herein, “optical transmission” refers to the amount of light that passes through a sample (e.g., a sol effluent or casting sol) divided by the total amount of light incident upon the sample. The percent optical transmission may be calculated using the equation

100(I/I_{O})

where I is the light intensity passing though the sample and I_{O} is the light intensity incident on the sample. The optical transmission through the sol effluent is often related to the optical transmission through the casting sol (reaction mixture used to form the gel composition). Good transmission helps ensure that adequate curing occurs during the formation of the gel composition and provides a greater depth of cure within the gel composition.

The optical transmission may be determined using an ultraviolet/visible spectrophotometer set, for example, at a wavelength of 420 nanometers or 600 nanometers with a 1 centimeter path length. The optical transmission is a function of the amount of zirconia in a sol. For sol effluents containing about 1 weight percent zirconia, the optical transmission is typically at least 70 percent, at least 80 percent, at least 85 percent, or at least 90 percent at either 420 nanometers or 600 nanometers. For sol effluents containing about 10 weight percent zirconia, the optical transmission is typically at least 20 percent, at least 25 percent, at least 30 percent, at least 40 percent, at least 50 percent, or at least 70 percent at either 420 nanometers or 600 nanometers.

The zirconia-based particles in the sol effluent are crystalline and can be cubic, tetragonal, monoclinic, or a combination thereof. Because the cubic and tetragonal phases are difficult to differentiate using x-ray diffraction techniques, these two phases are typically combined for quantitative purposes and are referred to as the “cubic/tetragonal” phases. The percent cubic/tetragonal phase can be determined, for example, by measuring the peak area of the x-ray diffraction peaks for each phase and using the following equation.

% C/T=100(C/T)+(C/T+M)

In this equation, “C/T” refers to the area of the diffraction peak for the cubic/tetragonal phase, “M” refers to the area of the diffraction peak for the monoclinic phase, and “% C/T” refers to the weight percent cubic/tetragonal crystalline phase. The details of the x-ray diffraction measurements are described further in the Example section below.

Typically, at least 50 weight percent of the zirconia-based particles in the sol effluent have a cubic structure, tetragonal structure, or a combination thereof. A greater content of the cubic/tetragonal phase is usually desired. The amount of cubic/tetragonal phase is often at least 60 weight percent, at least 70 weight percent, at least 75 weight percent, at least 80 weight percent, at least 85 weight percent, at least 90 weight percent, or at least 95 weight percent based on a total weight of all crystalline phases present in the zirconia-based particles.

For example, cubic/tetragonal crystals have been observed to be associated with the formation of low aspect ratio primary particles having a cube-like shape when viewed under an electron microscope. This particle shape tends to be relatively easily dispersed into a liquid matrix. Typically, the zirconia particles have an average primary particle size up to 50 nanometers although larger sizes may also be useful. For example, the average primary particle size can be up to 40 nanometers, up to 35 nanometers, up to 30 nanometers, up to 25 nanometers, up to 20 nanometers, up to 15 nanometers, or even up to 10 nanometers. The average primary particle size is often at least 1 nanometer, at least 2 nanometers, at least 3 nanometers, or at least 5 nanometers. The average primary particle size, which refers to the non-associated particle size of the zirconia particles, can be determined by x-ray diffraction as described in the Example section. Zirconia sols described herein typically have primary particle size in a range of 2 to 50 nanometers. In some embodiments, the average primary particle size is in a range of 5 to 50 nanometers, 2 to 40 nanometers, 5 to 40 nanometers, 2 to 25 nanometers, 5 to 25 nanometers, 2 to 20 nanometers, 5 to 20 nanometers, 2 to 15 nanometers, 5 to 15 nanometers, or 2 to 10 nanometers.

In some embodiments, the particles in the sol effluent are non-associated and the average particle size is the same as the primary particle size. In some embodiments, the particles are aggregated or agglomerated to a size up to 100 nanometers. The extent of association between the primary particles can be determined from the volume-average particle size. The volume-average particle size can be measured using Photon Correlation Spectroscopy as described in more detail in the Examples section below. Briefly, the volume distribution (percentage of the total volume corresponding to a given size range) of the particles is measured. The volume of a particle is proportional to the third power of the diameter. The volume-average size is the size of a particle that corresponds to the mean of the volume distribution. If the zirconia-based particles are associated, the volume-average particle size provides a measure of the size of the aggregate and/or agglomerate of primary particles. If the particles of zirconia are non-associated, the volume-average particle size provides a measure of the size of the primary particles. The zirconia-based particles typically have a volume-average size of up to 100 nanometers. For example, the volume-average size can be up to 90 nanometers, up to 80 nanometers, up to 75 nanometers, up to 70 nanometers, up to 60 nanometers, up to 50 nanometers, up to 40 nanometers, up to 30 nanometers, up to 25 nanometers, up to 20 nanometers, or up to 15 nanometers, or even up to 10 nanometers.

A quantitative measure of the degree of association between the primary particles in the sol effluent is the dispersion index. As used herein the “dispersion index” is defined as the volume-average particle size divided by the primary particle size. The primary particle size (e.g., the weighted average crystallite size) is determined using x-ray diffraction techniques and the volume-average particle size is determined using Photon Correlation Spectroscopy. As the association between primary particles decreases, the dispersion index approaches a value of 1 but can be somewhat higher or lower. The zirconia-based particles typically have a dispersion index in a range of from 1 to 7. For example, the dispersion index is often in a range 1 to 5, 1 to 4, 1 to 3, 1 to 2.5, or even 1 to 2.

Photon Correlation Spectroscopy also can be used to calculate the Z-average primary particle size. The Z-average size is calculated from the fluctuations in the intensity of scattered light using a cumulative analysis and is proportional to the sixth power of the particle diameter. The volume-average size will typically be a smaller value than the Z-average size. The zirconia-based particles tend to have a Z-average size that is up to 100 nanometers. For example, the Z-average size can be up to 90 nanometers, up to 80 nanometers, up to 70 nanometers, up to 60 nanometers, up to 50 nanometers, up to 40 nanometers, up to 35 nanometers, up to 30 nanometers, up to 20 nanometers, or even up to 15 nanometers.

Depending on how the zirconia-based particles are prepared, the particles may contain at least some organic material in addition to the inorganic oxides. For example, if the particles are prepared using a hydrothermal approach, there may be some organic material attached to the surface of the zirconia-based particles. Although not wanting to be bound by theory, it is believed that organic material originates from the carboxylate species (anion, acid, or both) included in the feedstock or formed as a byproduct of the hydrolysis and condensation reactions (i.e., organic material is often absorbed on the surface of the zirconia-based particles). For example, the zirconia-based particles contain up to 15 weight percent, up to 12 weight percent, up to 10 weight percent, up to 8 weight percent, or even up to 5 weight percent organic material based on a total weight of the zirconia-based particles.

The reaction mixture (casting sol) used to form the gel composition typically contains 20 to 60 weight percent zirconia-based particles based on a total weight of the reaction mixture. The amount of zirconia-based particles can be at least 25 weight percent, at least 30 weight percent, at least 35 weight percent, or at least 40 weight percent and can be up to 55 weight percent, up to 50 weight percent, or up to 45 weight percent. In some embodiments, the amount of the zirconia-based particles is in a range of 25 to 55 weight percent, 30 to 50 weight percent, 30 to 45 weight percent, 35 to 50 weight percent, 40 to 50 weight percent, or 35 to 45 weight percent based on the total weight of the reaction mixture used for the gel composition.

2. Solvent Medium

The sol effluent, which is the effluent from the hydrothermal reactor, contains the zirconia-based particles suspended in an aqueous medium. The aqueous medium is predominately water but can contain carboxylic acid and/or carboxylate anions. For the reaction mixture (casting sol) used to form the gel composition and the shaped gel article, the aqueous medium is replaced with a solvent medium that contains at least 60 weight percent of an organic solvent having a boiling point equal to at least 150° C. In some embodiments, the solvent medium contains at least 70 weight percent, at least 80 weight percent, at least 90 weight percent, at least 95 weight percent, at least 97 weight percent, at least 98 weight percent, or at least 99 weight percent of the organic solvent having a boiling point equal to at least 150° C. The boiling point is often at least 160° C., at least 170° C., at least 180° C., or at least 190° C.

Any suitable method can be used to replace the aqueous medium from the sol effluent with the solvent medium that is predominately the organic solvent having a boiling point equal to at least 150° C. In many embodiments, the sol effluent from the hydrothermal reactor system is concentrated to at least partially remove the water as well as the carboxylic acid and/or carboxylate anion. The aqueous medium is often concentrated using methods such as drying or vaporization, solvent exchange, dialysis, diafiltration, ultrafiltration, or a combination thereof.

In some embodiments, the sol effluent of the hydrothermal reactor is concentrated with a drying process. Any suitable drying method can be used such as spray drying or oven drying. For example, the sol effluent can be dried in a conventional oven at a temperature equal to at least 80° C., at least 90° C., at least 100° C., at least 110° C., or at least 120° C. The drying time is often greater than 1 hour, greater than 2 hours, or greater than 3 hours. The dried effluent can then be re-suspended in the organic solvent having a boiling point equal to at least 150° C.

In other embodiments, the sol effluent of the hydrothermal treatment can be subjected to ultrafiltration, dialysis, diafiltration, or a combination thereof to form a concentrated sol. Ultrafiltration provides concentration only. Dialysis and diafiltration both tend to remove at least a portion of the dissolved carboxylic acids and/or carboxylate anions in the sol effluent. For dialysis, a sample of the sol effluent can be positioned within a membrane bag that is closed and then placed within a water bath. The carboxylic acid and/or carboxylate anions diffuse out of the sample within the membrane bag. That is, these species will diffuse out of the sol effluent through the membrane bag into the water bath to equalize the concentration within the membrane bag to the concentration in the water bath. The water in the bath is typically replaced several times to lower the concentration of species within the bag. A membrane bag is typically selected that allows diffusion of the carboxylic acids and/or anions thereof but that does not allow diffusion of the zirconia-based particles out of the membrane bag.

For diafiltration, a permeable membrane is used to filter the sample. The zirconia particles can be retained by the filter if the pore size of the filter is appropriately chosen. The dissolved carboxylic acids and/or anions thereof pass through the filter. Any liquid that passes through the filter is replaced with fresh water. In a discontinuous diafiltration process, the sample is often diluted to a pre-determined volume and then concentrated back to the original volume by ultrafiltration. The dilution and concentration steps are repeated one or more times until the carboxylic acid and/or anions thereof are removed or lowered to an acceptable concentration level. In a continuous diafiltration process, which is often referred to as a constant volume diafiltration process, fresh water is added at the same rate that liquid is removed through filtration. The dissolved carboxylic acid and/or anions thereof are in the liquid that is removed.

While the majority of the inorganic oxides in the zirconia-based particles are incorporated into the crystalline material, there may be a fraction that can be removed during diafiltration or dialysis. The actual composition of the zirconia-based particles after diafiltration or dialysis may be different than in the sol effluent from the hydrothermal reactor or from the composition expected based on the various salts included in the feedstock for the hydrothermal reactor. For example, a sol effluent prepared to have a composition of 89.9/9.6/0.5 ZrO₂/Y₂O₃/La₂O₃ had the following composition after diafiltration: 90.6/8.1/0.24 ZrO₂/Y₂O₃/La₂O₃ and a sol effluent prepared to have a composition of 97.7/2.3 ZrO₂/Y₂O₃ had the same composition after diafiltration.

Through ultrafiltration, dialysis, diafiltration, or a combination thereof, the concentrated sol often has a weight percent solids equal to at least 10 weight percent, at least 20 weight percent, 25 weight percent or at least 30 weight percent and up 60 weight percent, up to 55 weight percent, up to 50 weight percent, or up to 45 weight percent solids. For example, the weight percent solids are often in a range of 10 to 60 weight percent, 20 to 50 weight percent, 25 to 50 weight percent, 25 to 45 weight percent, 30 to 50 weight percent, 35 to 50 weight percent, or 40 to 50 weight percent based on the total weight of the concentrated sol.

The carboxylic acid content (e.g., acetic acid content) of the concentrated sol is often at least 2 weight percent and can be up to 15 weight percent. In some embodiments, the carboxylic acid content is at least 3 weight percent, at least 5 weight percent and can be up to 12 weight percent, or up to 10 weight percent. For example, the carboxylic acid can be present in an amount in a range of 2 to 15 weight percent, 3 to 15 weight percent, 5 to 15 weight percent, or 5 to 12 weight percent based on the total weight of the concentrated sol.

Usually, most of the aqueous medium is removed from the concentrated sol prior to formation of the gel composition. Additional water is often removed using a solvent exchange process. For example, the organic solvent having a boiling point equal to at least 150° C. can be added to the concentrated sol; water plus any remaining carboxylic acid can be removed by distillation. A rotary evaporator is often used for the distillation process.

Suitable organic solvents that have a boiling point equal to 150° C. are typically selected to be miscible with water. Further, these organic solvents are often selected to be soluble in supercritical carbon dioxide or liquid carbon dioxide. The molecular weight of the organic solvent is usually at least 25 grams/mole, at least 30 grams/mole, at least 40 grams/mole, at least 45 grams/mole, at least 50 grams/mole, at least 75 grams/mole, or at least 100 grams/mole. The molecular weight can be up to 300 grams/mole or higher, up to 250 grams/mole, up to 225 grams/mole, up to 200 grams/mole, up to 175 grams/mole, or up to 150 grams/mole. The molecular weight is often in a range of 25 to 300 grams/mole, 40 to 300 grams/mole, 50 to 200 grams/mole, or 75 to 175 grams/mole.

The organic solvent is often a glycol or polyglycol, mono-ether glycol or mono-ether polyglycol, di-ether glycol or di-ether polyglycol, ether ester glycol or ether ester polyglycol, carbonate, amide, or sulfoxide (e.g., dimethyl sulfoxide). The organic solvents usually have one or more polar groups. The organic solvent does not have a polymerizable group; that is, the organic solvent is free of a group that can undergo free radical polymerization. Further, no component of the solvent medium has a polymerizable group that can undergo free radical polymerization.

Suitable glycols or polyglycols, mono-ether glycols or mono-ether polyglycols, di-ether glycols or di-ether polyglycols, and ether ester glycols or ether ester polyglycols are often of Formula (I).

R¹O—(R²O)ₙ—R¹ (I)

In Formula (I), each R¹ independently is hydrogen, alkyl, aryl, or acyl. Suitable alkyl groups often have 1 to 10 carbon atoms, 1 to 6 carbon atoms, or 1 to 4 carbon atoms. Suitable aryl groups often have 6 to 10 carbon atoms and are often phenyl or phenyl substituted with an alkyl group having 1 to 4 carbon atoms. Suitable acyl groups are often of formula —(CO)R^{a} where R^{a} is an alkyl having 1 to 10 carbon atoms, 1 to 6 carbon atoms, 1 to 4 carbon atoms, 2 carbon atoms, or 1 carbon atom. The acyl is often an acetate group (—(CO)CH₃). In Formula (I), each R² is typically ethylene or propylene. The variable n is at least 1 and can be in a range of 1 to 10, 1 to 6, 1 to 4, or 1 to 3.

Glycols or polyglycols of Formula (I) have two R¹ groups equal to hydrogen. Examples of glycols include, but are not limited to, ethylene glycol, propylene glycol, diethylene glycol, dipropylene glycol, triethylene glycol, and tripropylene glycol.

Mono-ether glycols or mono-ether polyglycols of Formula (I) have a first R¹ group equal to hydrogen and a second R¹ group equal to alkyl or aryl. Examples of mono-ether glycols or mono-ether polyglycols include, but are not limited to, ethylene glycol monohexyl ether, ethylene glycol monophenyl ether, propylene glycol monobutyl ether, diethylene glycol monomethyl ether, diethylene glycol monoethyl ether, diethylene glycol monopropyl ether, diethylene glycol monobutyl ether, diethylene glycol monohexyl ether, dipropylene glycol monomethyl ether, dipropylene glycol monoethyl ether, dipropylene glycol monopropyl ether, triethylene glycol monomethyl ether, triethylene glycol monoethyl ether, triethylene glycol monobutyl ether, tripropylene glycol monomethyl ether, and tripropylene glycol monobutyl ether.

Di-ether glycols or di-ether polyglycols of Formula (I) have two R¹ group equal to alkyl or aryl. Examples of di-ether glycols or di-ether polyglycols include, but are not limited to, ethylene glycol dipropyl ether, ethylene glycol dibutyl ether, dipropylene glycol dibutyl ether, diethylene glycol dimethyl ether, diethylene glycol diethyl ether, triethylene glycol dimethyl ether, tetraethylene glycol dimethyl ether, and pentaethylene glycol dimethyl ether.

Ether ester glycols or ether ester polyglycols of Formula (I) have a first R¹ group equal to an alkyl or aryl and a second R¹ group equal to an acyl. Examples of ether ester glycols or ether ester polyglycols include, but are not limited to, ethylene glycol butyl ether acetate, diethylene glycol butyl ether acetate, and diethylene glycol ethyl ether acetate.

Other suitable organic solvents are carbonates of Formula (II).

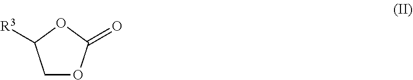

In Formula (II), R³ is hydrogen or an alkyl such as an alkyl having 1 to 4 carbon atoms, 1 to 3 carbon atoms, or 1 carbon atom. Examples include ethylene carbonate and propylene carbonate.

Yet other suitable organic solvents are amides of Formula (III).

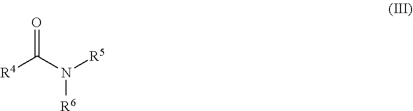

In Formula (III), group R⁴ is hydrogen, alkyl, or combines with R⁵ to form a five-membered ring including the carbonyl attached to R⁴ and the nitrogen atom attached to R. Group R⁵ is hydrogen, alkyl, or combines with R⁴ to form a five-membered ring including the carbonyl attached to R⁴ and the nitrogen atom attached to R. Group R⁶ is hydrogen or alkyl. Suitable alkyl groups for R⁴, R⁵, and R have 1 to 6 carbon atoms, 1 to 4 carbon atoms, 1 to 3 carbon atoms, or 1 carbon atom. Examples of amide organic solvents of Formula (III) include, but are not limited to, formamide, N,N-dimethylformamide, N,N-dimethylacetamide, N,N-diethylacetamide, N-methyl-2-pyrrolidone, and N-ethyl-2-pyrrolidone.

The solvent medium typically contains less than 15 weight percent water, less than 10 percent water, less than 5 percent water, less than 3 percent water, less than 2 percent water, less than 1 weight percent, or even less than 0.5 weight percent water after the solvent exchange (e.g., distillation) process.

The reaction mixture often includes at least 30 weight percent solvent medium. In some embodiments, the reaction mixture contains at least 35 weight percent, or at least 40 weight percent solvent medium. The reaction mixture can contain up to 75 weight percent, up to 70 weight percent, up to 65 weight percent, up to 60 weight percent, up to 55 weight percent, up to 50 weight percent, or up to 45 weight percent solvent medium. For example, the reaction mixture can contain 30 to 75 weight percent, 30 to 70 weight percent, 30 to 60 weight percent, 30 to 50 weight percent, 30 to 45 weight percent, 35 to 60 weight percent, 35 to 55 weight percent, 35 to 50 weight percent, or 40 to 50 weight percent solvent medium. The weight percent values are based on the total weight of the reaction mixture.

An optional surface modification agent (which can be referred to as a non-polymerizable surface modification agent) is often dissolved in the organic solvent prior to the solvent exchange process. The optional surface modification agent typically is free of a polymerizable group that can undergo free radical polymerization reactions. The optional surface modification agent is usually a carboxylic acid or salt thereof, sulfonic acid or salt thereof, phosphoric acid or salt thereof, phosphonic acid or salt thereof, or silane that can attach to a surface of the zirconia-based particles. In many embodiments, the optional surface modification agents are carboxylic acids that do not contain a polymerizable group that can undergo a free radical polymerization reaction.

In some embodiments, the optional non-polymerizable surface modification agent is a carboxylic acid and/or anion thereof and has a compatibility group that imparts a polar character to the zirconia-based nanoparticles. For example, the surface modification agent can be a carboxylic acid and/or anion thereof having an alkylene oxide or polyalkylene oxide group. In some embodiments, the carboxylic acid surface modification agent is of the following formula.

H₃CO—[(CH₂)_{y}O]_{z}-Q-COOH

In this formula, Q is a divalent organic linking group, z is an integer in the range of 1 to 10, and y is an integer in the range of 1 to 4. The group Q includes at least one alkylene group or arylene group and can further include one or more oxy, thio, carbonyloxy, carbonylimino groups. Representative examples of this formula include, but are not limited to, 2-[2-(2-methoxyethoxy)ethoxy]acetic acid (MEEAA) and 2-(2-methoxyethoxy)acetic acid (MEAA). Still other representative carboxylic acids are the reaction product of an aliphatic anhydride and a polyalkylene oxide mono-ether such as succinic acid mono-[2-(2-methoxy-ethoxy)-ethyl] ester, and glutaric acid mono-[2-(2-methoxy-ethoxy)-ethyl] ester.

In other embodiments, the optional non-polymerizable surface modification agent is a carboxylic acid and/or anion thereof and the compatibility group can impart a non-polar character to the zirconia-containing nanoparticles. For example, the surface modification agent can be a carboxylic acid of formula R^{c}—COOH or a salt thereof where R^{c} is an alkyl group having at least 5 carbon atoms, at least 6 carbon atoms, at least 8 carbon atoms, or at least 10 carbon atoms. R^{c} often has up to 20 carbon atoms, up to 18 carbon atoms, or up to 12 carbon atoms. Representative examples include octanoic acid, lauric acid, dodecanoic acid, stearic acid, and combinations thereof.

In addition to modifying the surface of the zirconia-based particles to minimize the likelihood of agglomeration and/or aggregation when the sol is concentrated, the optional non-polymerizable surface modification agent can be used to adjust the viscosity of the sol.

Any suitable amount of the optional non-polymerizable surface modification agent can be used. If present, the optional non-polymerizable surface modification agent usually is added in an amount equal to at least 0.5 weight percent based on the weight of the zirconia-based particles. For example, the amount can be equal to at least 1 weight percent, at least 2 weight percent, at least 3 weight percent, at least 4 weight percent, or at least 5 weight percent and can be up to 15 weight percent or more, up to 12 weight percent, up to 10 weight percent, up to 8 weight percent, or up to 6 weight percent. The amount of the optional non-polymerizable surface modification agent is typically in a range of 0 to 15 weight percent, 0.5 to 15 weight percent, 0.5 to 10 weight percent, 1 to 10 weight percent, or 3 to 10 weight percent based on the weight of the zirconia-based particles.

Stated differently, the amount of the optional non-polymerizable surface modification agent is often in a range of 0 to 10 weight percent based on a total weight of the reaction mixture. The amount is often at least 0.5 weight percent, at least 1 weight percent, at least 2 weight percent, or at least 3 weight percent and can be up to 10 weight percent, up to 8 weight percent, up to 6 weight percent, or up to 5 weight percent based on the total weight of the reaction mixture.

3. Polymerizable Material

The reaction mixture includes one or more polymerizable materials that have a polymerizable group that can undergo free radical polymerization (i.e., the polymerizable group is free radical polymerizable). In many embodiments, the polymerizable group is an ethylenically unsaturated group such as a (meth)acryloyl group, which is a group of formula —(CO)—CR^{b}═CH₂ where R^{b} is hydrogen or methyl. In some embodiments, the polymerizable group is a vinyl group (—CH═CH₂) that is not a (meth)acryloyl group. The polymerizable material is usually selected so that it is soluble in or miscible with the organic solvent having a boiling point equal to at least 150° C.

The polymerizable material includes a first monomer that is a surface modification agent having a free radical polymerizable group. The first monomer typically modifies the surface of the zirconia-based particles. Suitable first monomers have a surface modifying group that can attach to a surface of the zirconia-based particles. The surface modifying group is usually a carboxyl group (—COOH or an anion thereof) or a silyl group of formula —Si(R⁷)ₓ(R)₃₋ₓ where R⁷ is a non-hydrolyzable group, R⁸ is hydroxyl or a hydrolyzable group, and the variable x is an integer equal to 0, 1, or 2. Suitable non-hydrolyzable groups are often alkyl groups such as those having 1 to 10, 1 to 6, 1 to 4, or 1 to 2 carbon atoms. Suitable hydrolyzable groups are often a halo (e.g., chloro), acetoxy, alkoxy group having 1 to 10, 1 to 6, 1 to 4, or 1 to 2 carbon atoms, or group of formula —OR^{d}—OR^{e} where R^{d} is an alkylene having 1 to 4 or 1 to 2 carbon atoms and R^{e} is an alkyl having 1 to 4 or 1 to 2 carbon atoms.

In some embodiments, the first monomer has a carboxyl group. Examples of first monomers with a carboxyl group include, but are not limited to, (meth)acrylic acid, itaconic acid, maleic acid, crotonic acid, citraconic acid, oleic acid, and beta-carboxyethyl acrylate. Other examples of first monomers having a carboxyl group are the reaction product of hydroxyl-containing polymerizable monomers with a cyclic anhydride such as maleic anhydride, succinic anhydride, or phthalic anhydride. Suitable hydroxyl-containing polymerizable monomers include, for example, hydroxyethyl (meth)acrylate, hydroxypropyl (meth)acrylate, and hydroxybutyl (meth)acrylate. A specific example of these reaction products include, but are not limited to, mono-2-(methacryloxyethyl)succinate (e.g., this is often called hydroxyethyl acrylate succinate). In many embodiments, the first monomer is a (meth)acrylic acid.

In other embodiments, the first monomer has a silyl group of formula —Si(R⁷)ₓ(R)₃₋ₓ. Examples of first monomers with a silyl group include, but are not limited to, (meth)acryloxyalkyltrialkoxysilanes (e.g., 3-(meth)acryloxypropyltrimethoxysilane, and 3-(meth)acryloxypropyltriethoxysilane), (meth)acryloxyalkylalkyldialkoxysilanes (e.g., 3-(meth)acryloxypropylmethyldimethoxysilane), (meth)acrloxyalkyldialkylalkoxysilane (e.g., 3-(meth)acryloxypropyldimethylethoxysilane), styrylalkyltrialkoxysilane (e.g., styrylethyltrimethoxysilane), vinyl trialkoxysilane (e.g., vinyltrimethoxysilane, vinyltriethoxysilane, and vinyltriisopropoxysilane), vinylalkyldialkoxysilanes (e.g., vinylmethyldiethoxylsilane), and vinyldialkylalkoxysilane (e.g., vinyldimethylethoxysilane), vinyltriacetoxysilane, vinylalkyldiacetoxysilane (e.g., vinylmethyldiacetoxysilane), and vinyltris(alkoxyalkoxy)silane (e.g., vinyltris(2-methoxyethoxy)silane).

The first monomer can function as a polymerizable surface modification agent. Multiple first monomers can be used. The first monomer can be the only kind of surface modification agent or can be combined with one or more non-polymerizable surface modification agents such as those discussed above. In some embodiments, the amount of the first monomer is at least 20 weight percent based on a total weight of polymerizable material. For example, the amount of the first monomer is often at least 25 weight percent, at least 30 weight percent, at least 35 weight percent, or at least 40 weight percent. The amount of the first monomer can be up to 100 percent, up to 90 weight percent, up to 80 weight percent, up to 70 weight percent, up to 60 weight percent, or up to 50 weight percent. Some reaction mixtures contain 20 to 100 weight percent, 20 to 80 weight percent, 20 to 60 weight percent, 20 to 50 weight percent, or 30 to 50 weight percent of the first monomer based on a total weight of polymerizable material.

The first monomer (i.e., the polymerizable surface modification monomer) can be the only monomer in the polymerizable material or can be combined with one or more second monomers that are soluble in the solvent medium. Any suitable second monomer that does not have a surface modification group can be used. That is, the second monomer does not have a carboxyl group or a silyl group. The second monomers are often polar monomers (e.g., non-acidic polar monomers), monomers having a plurality of polymerizable groups, alkyl (meth)acrylates, and mixtures thereof.

The overall composition of the polymerizable material is often selected so that the polymerized material is soluble in the solvent medium. Homogeneity of the organic phase is often preferable to avoid phase separation of the organic component in the gel composition. This tends to result in the formation of smaller and more homogeneous pores (pores with a narrower size distribution) in the subsequently formed xerogel or aerogel. Further, the overall composition of the polymerizable material can be selected to adjust compatibility with the solvent medium and to adjust the strength, flexibility, and uniformity of the gel composition. Still further, the overall composition of the polymerizable material can be selected to adjust the burnout characteristics of the organic material prior to sintering.

In many embodiments, the second monomer includes a monomer having a plurality of polymerizable groups. The number of polymerizable groups can be in a range of 2 to 6 or even higher. In many embodiments, the number of polymerizable groups is in a range of 2 to 5 or 2 to 4. The polymerizable groups are typically (meth)acryloyl groups.

Exemplary monomers with two (meth)acryloyl groups include 1,2-ethanediol diacrylate, 1,3-propanediol diacrylate, 1,9-nonanediol diacrylate, 1,12-dodecanediol diacrylate, 1,4-butanediol diacrylate, 1,6-hexanediol diacrylate, butylene glycol diacrylate, bisphenol A diacrylate, diethylene glycol diacrylate, triethylene glycol diacrylate, tetraethylene glycol diacrylate, tripropylene glycol diacrylate, polyethylene glycol diacrylate, polypropylene glycol diacrylate, polyethylene/polypropylene copolymer diacrylate, polybutadiene di(meth)acrylate, propoxylated glycerin tri(meth)acrylate, and neopentylglycol hydroxypivalate diacrylate modified caprolactone.

Exemplary monomers with three or four (meth)acryloyl groups include, but are not limited to, trimethylolpropane triacrylate (e.g., commercially available under the trade designation TMPTA-N from Cytec Industries, Inc. (Smyrna, GA, USA) and under the trade designation SR-351 from Sartomer (Exton, PA, USA)), pentaerythritol triacrylate (e.g., commercially available under the trade designation SR-444 from Sartomer), ethoxylated (3) trimethylolpropane triacrylate (e.g., commercially available under the trade designation SR-454 from Sartomer), ethoxylated (4) pentaertythriol tetraacrylate (e.g., commercially available under the trade designation SR-494 from Sartomer), tris(2-hydroxyethylisocyanurate) triacrylate (e.g., commercially available under the trade designation SR-368 from Sartomer), a mixture of pentaerythritol triacrylate and pentaerythritol tetraacrylate (e.g., commercially available from Cytec Industries, Inc., under the trade designation PETIA with an approximately 1:1 ratio of tetraacrylate to triacrylate and under the trade designation PETA-K with an approximately 3:1 ratio of tetraacrylate to triacrylate), pentaerythritol tetraacrylate (e.g., commercially available under the trade designation SR-295 from Sartomer), and di-trimethylolpropane tetraacrylate (e.g., commercially available under the trade designation SR-355 from Sartomer).

Exemplary monomers with five or six (meth)acryloyl groups include, but are not limited to, dipentaerythritol pentaacrylate (e.g., commercially available under the trade designation SR-399 from Sartomer) and a hexa-functional urethane acrylate (e.g., commercially available under the trade designation CN975 from Sartomer).

Some polymerizable compositions contain 0 to 80 weight percent of a monomer having a plurality of polymerizable groups based on a total weight of the polymerizable material. For example, the amount can be in a range of 10 to 80 weight percent, 20 to 80 weight percent, 30 to 80 weight percent, 40 to 80 weight percent, 10 to 70 weight percent, 10 to 50 weight percent, 10 to 40 weight percent, or 10 to 30 weight percent. The presence of the monomer having a plurality of polymerizable groups tends to enhance the strength of the gel composition formed when the reaction mixture is polymerized. Such gel compositions can be easier to remove from the mold without cracking. The amount of the monomer with a plurality of the polymerizable groups can be used to adjust the flexibility and the strength of the gel composition.

In some embodiments, the optional second monomer is a polar monomer. As used herein, the term “polar monomer” refers to a monomer having a free radical polymerizable group and a polar group. The polar group is typically non-acidic and often contains a hydroxyl group, a primary amido group, a secondary amido group, a tertiary amido group, an amino group, or an ether group (i.e., a group containing at least one alkylene-oxy-alkylene group of formula —R—O—R— where each R is an alkylene having 1 to 4 carbon atoms).

Suitable optional polar monomers having a hydroxyl group include, but are not limited to, hydroxyalkyl (meth)acrylates (e.g., 2-hydroxyethyl (meth)acrylate, 2-hydroxypropyl (meth)acrylate, 3-hydroxypropyl (meth)acrylate, and 4-hydroxybutyl (meth)acrylate), and hydroxyalkyl (meth)acrylamides (e.g., 2-hydroxyethyl (meth)acrylamide or 3-hydroxypropyl (meth)acrylamide), ethoxylated hydroxyethyl (meth)acrylate (e.g., monomers commercially available from Sartomer (Exton, PA, USA) under the trade designation CD570, CD571, and CD572), and aryloxy substituted hydroxyalkyl (meth)acrylates (e.g., 2-hydroxy-2-phenoxypropyl (meth)acrylate).

Exemplary polar monomers with a primary amido group include (meth)acrylamide. Exemplary polar monomers with secondary amido groups include, but are not limited to, N-alkyl (meth)acrylamides such as N-methyl (meth)acrylamide, N-ethyl (meth)acrylamide, N-isopropyl (meth)acrylamide, N-tert-octyl (meth)acrylamide, and N-octyl (meth)acrylamide. Exemplary polar monomers with a tertiary amido group include, but are not limited to, N-vinyl caprolactam, N-vinyl-2-pyrrolidone, (meth)acryloyl morpholine, and N,N-dialkyl (meth)acrylamides such as N,N-dimethyl (meth)acrylamide, N,N-diethyl (meth)acrylamide, N,N-dipropyl (meth)acrylamide, and N,N-dibutyl (meth)acrylamide.

Polar monomers with an amino group include various N,N-dialkylaminoalkyl (meth)acrylates and N,N-dialkylaminoalkyl (meth)acrylamides. Examples include, but are not limited to, N,N-dimethyl aminoethyl (meth)acrylate, N,N-dimethylaminoethyl (meth)acrylamide, N,N-dimethylaminopropyl (meth)acrylate, N,N-dimethylaminopropyl (meth)acrylamide, N,N-diethylaminoethyl (meth)acrylate, N,N-diethylaminoethyl (meth)acrylamide, N,N-diethylaminopropyl (meth)acrylate, and N,N-diethylaminopropyl (meth)acrylamide.

Exemplary polar monomers with an ether group include, but are not limited to, alkoxylated alkyl (meth)acrylates such as ethoxyethoxyethyl (meth)acrylate, 2-methoxyethyl (meth)acrylate, and 2-ethoxyethyl (meth)acrylate; and poly(alkylene oxide) (meth)acrylates such as poly(ethylene oxide) (meth)acrylates, and poly(propylene oxide) (meth)acrylates. The poly(alkylene oxide) acrylates are often referred to as poly(alkylene glycol) (meth)acrylates. These monomers can have any suitable end group such as a hydroxyl group or an alkoxy group. For example, when the end group is a methoxy group, the monomer can be referred to as methoxy poly(ethylene glycol) (meth)acrylate.

Suitable alkyl (meth)acrylates that can be used as a second monomer can have an alkyl group with a linear, branched, or cyclic structure. Examples of suitable alkyl (meth)acrylates include, but are not limited to, methyl (meth)acrylate, ethyl (meth)acrylate, n-propyl (meth)acrylate, isopropyl (meth)acrylate, n-butyl (meth)acrylate, isobutyl (meth)acrylate, n-pentyl (meth)acrylate, 2-methylbutyl (meth)acrylate, n-hexyl (meth)acrylate, cyclohexyl (meth)acrylate, 4-methyl-2-pentyl (meth)acrylate, 2-ethylhexyl (meth)acrylate, 2-methylhexyl (meth)acrylate, n-octyl (meth)acrylate, isooctyl (meth)acrylate, 2-octyl (meth)acrylate, isononyl (meth)acrylate, isoamyl (meth)acrylate, 3,3,5-trimethylcyclohexyl (meth)acrylate, n-decyl (meth)acrylate, isodecyl (meth)acrylate, isobornyl (meth)acrylate, 2-propylheptyl (meth)acrylate, isotridecyl (meth)acrylate, isostearyl (meth)acrylate, octadecyl (meth)acrylate, 2-octyldecyl (meth)acrylate, dodecyl (meth)acrylate, lauryl (meth)acrylate, and heptadecanyl (meth)acrylate.

The amount of a second monomer that is a polar monomer and/or an alkyl (meth)acrylate monomer is often in a range of 0 to 40 weight percent, 0 to 35 weight percent, 0 to 30 weight percent, 5 to 40 weight percent, or 10 to 40 weight percent based on a total weight of the polymerizable material.

Overall, the polymerizable material typically contains 20 to 100 weight percent first monomer and 0 to 80 weight percent second monomer based on a total weight of polymerizable material. For example, polymerizable material includes 30 to 100 weight percent first monomer and 0 to 70 weight percent second monomer, 30 to 90 weight percent first monomer and 10 to 70 weight percent second monomer, 30 to 80 weight percent first monomer and 20 to 70 weight percent second monomer, 30 to 70 weight percent first monomer and 30 to 70 weight percent second monomer, 40 to 90 weight percent first monomer and 10 to 60 weight percent second monomer, 40 to 80 weight percent first monomer and 20 to 60 weight percent second monomer, 50 to 90 weight percent first monomer and 10 to 50 weight percent second monomer, or 60 to 90 weight percent first monomer and 10 to 40 weight percent second monomer.

In some applications, it can be advantageous to minimize the weight ratio of polymerizable material to zirconia-based particles in the reaction mixture. This tends to reduce the amount of decomposition products of organic material that needs to be burned out prior to formation of the sintered article. The weight ratio of polymerizable material to zirconia-based particles is often at least 0.05, at least 0.08, at least 0.09, at least 0.1, at least 0.11, or at least 0.12. The weight ratio of polymerizable material to zirconia-based particles can be up to 0.80, up to 0.6, up to 0.4, up to 0.3, up to 0.2, or up to 0.1. For example, the ratio can be in a range of 0.05 to 0.8, 0.05 to 0.6, 0.05 to 0.4, 0.05 to 0.2, 0.05 to 0.1, 0.1 to 0.8, 0.1 to 0.4, or 0.1 to 0.3.

4. Photoinitiator

The reaction mixture used to form the gel composition contains a photoinitiator. The reaction mixtures advantageously are initiated by application of actinic radiation. That is, the polymerizable material is polymerized using a photoinitiator rather than a thermal initiator. Surprisingly, the use of a photoinitiator rather than a thermal initiator tends to result in a more uniform cure throughout the gel composition ensuring uniform shrinkage in subsequent steps involved in the formation of sintered articles. In addition, the outer surface of the cured part is more uniform and more defect free when a photoinitiator is used rather than a thermal initiator.

Photoinitiated polymerization reactions often lead to shorter curing times and fewer concerns about competing inhibition reactions compared to thermally initiated polymerization reactions. The curing times can be more easily controlled than with thermal initiated polymerization reactions that must be used with opaque reaction mixtures.

In most embodiments, the photoinitators are selected to respond to ultraviolet and/or visible radiation. Stated differently, the photoinitiators usually absorb light in a wavelength range of 200 to 600 nanometers, 300 to 600 nanometers, or 300 to 450 nanometers. Some exemplary photoinitiators are benzoin ethers (e.g., benzoin methyl ether or benzoin isopropyl ether) or substituted benzoin ethers (e.g., anisoin methyl ether). Other exemplary photoinitiators are substituted acetophenones such as 2,2-diethoxyacetophenone or 2,2-dimethoxy-2-phenylacetophenone (commercially available under the trade designation IRGACURE 651 from BASF Corp. (Florham Park, NJ, USA) or under the trade designation ESACURE KB-1 from Sartomer (Exton, PA, USA)). Other exemplary photoinitiators are substituted benzophenones such as 1-hydroxycyclohexyl benzophenone (available, for example, under the trade designation “IRGACURE 184” from Ciba Specialty Chemicals Corp., Tarrytown, NY). Still other exemplary photoinitiators are substituted alpha-ketols such as 2-methyl-2-hydroxypropiophenone, aromatic sulfonyl chlorides such as 2-naphthalenesulfonyl chloride, and photoactive oximes such as 1-phenyl-1,2-propanedione-2-(O-ethoxycarbonyl)oxime. Other suitable photoinitiators include camphoquinone, 1-hydroxycyclohexyl phenyl ketone (IRGACURE 184), bis(2,4,6-trimethylbenzoyl)phenylphosphineoxide (IRGACURE 819), 1-[4-(2-hydroxyethoxy)phenyl]-2-hydroxy-2-methyl-1-propane-1-one (IRGACURE 2959), 2-benzyl-2-dimethylamino-1-(4-morpholinophenyl)butanone (IRGACURE 369), 2-methyl-1-[4-(methylthio)phenyl]-2-morpholinopropan-1-one (IRGACURE 907), and 2-hydroxy-2-methyl-1-phenyl propan-1-one (DAROCUR 1173).

The photoinitiator is typically present in an amount in the range of 0.01 to 5 weight percent, in the range of 0.01 to 3 weight percent, 0.01 to 1 weight percent, or 0.01 to 0.5 weight percent based on a total weight of polymerizable material in the reaction mixture.

5. Inhibitors

The reaction mixture used to form the gel composition can include an optional inhibitor. The inhibitor can help prevent undesirable side reactions and can help moderate the polymerization reaction. Suitable inhibitors are often 4-hydroxy-TEMPO (4-hydroxy-2,2,6,6-tetramethylpiperidinyloxy) or a phenol derivative such as, for example, butylhydroxytoluene or p-methoxyphenol. The inhibitor is often used in an amount in a range of 0 to 0.5 weight percent based on the weight of polymerizable materials. For example, the inhibitor can be present in an amount equal to at least 0.001 weight percent, at least 0.005 weight percent, at least 0.01 weight percent. The amount can be up to 1 weight percent, up to 0.5 weight percent, or up to 0.1 weight percent.

### Gel Compositions

A gel composition is provided that includes a polymerized product of the reaction mixture (i.e., casting sol) described above. That is, the gel composition is a polymerized product of a reaction mixture that includes (a) 20 to 60 weight percent zirconia-based particles based on a total weight of the reaction mixture, the zirconia-based particles having an average particle size no greater than 100 nanometers and comprising at least 70 mole percent ZrO₂, (b) 30 to 75 weight percent of a solvent medium, the solvent medium comprising at least 60 percent of an organic solvent having a boiling point equal to at least 150° C., (c) 2 to 30 weight percent polymerizable material based on a total weight of the reaction mixture, the polymerizable material comprising a first surface modification agent having a free radical polymerizable group; and (d) a photoinitiator for a free radical polymerization reaction.

The reaction mixture is typically placed into a mold. Thus, an article is provided that includes (a) a mold having a mold cavity and (b) a reaction mixture positioned within the mold cavity and in contact with a surface of the mold cavity. The reaction mixture is the same as described above.

Each mold has at least one mold cavity. The reaction mixture is typically exposed to ultraviolet and/or visible radiation while in contact with a surface of the mold cavity. The polymerizable material within the reaction mixture undergoes free radical polymerization. Because the first monomer functions as a surface modification agent for the zirconia-based particles within the reaction mixture and is attached to a surface of the zirconia-based particles, polymerization results in the formation of a three-dimensional gel composition that binds together zirconia-based particles. This usually leads to a strong and resilient gel composition. This also can lead to homogeneous gel compositions with small pore sizes that can be sintered at relatively lower temperatures.

The gel composition is formed within a mold cavity. Thus, an article is provided that includes (a) a mold having a mold cavity and (b) a gel composition positioned within the mold cavity and in contact with a surface of the mold cavity. The gel composition includes a polymerized product of a reaction mixture and the reaction mixture is the same as described above.

Because the gel composition is formed within a mold cavity, it takes on a shape defined by the mold cavity. That is, a shaped gel article is provided that is a polymerized product of a reaction mixture, wherein the reaction mixture is positioned within a mold cavity during polymerization and wherein the shaped gel article retains both a size and shape identical to the mold cavity (except in regions where the mold cavity was overfilled) when removed from the mold. The reaction mixture is the same as described above.

The reaction mixture (casting sol) typically allows transmission of ultraviolet/visible radiation. The percent transmission of a casting sol composition containing 40 weight percent zirconia-based particles is typically at least 5 percent when measured at 420 nanometers in a 1 centimeter sample cell (i.e., the spectrophotometer has a 1 centimeter path length). In some examples, the percent transmission under these same conditions is at least 7 percent, at least 10 percent and can be up to 20 percent or higher, up to 15 percent, or up to 12 percent. The percent transmission of a casting sol composition containing 40 weight percent zirconia-based particles is typically at least 20 percent when measured at 600 nanometers in a 1 centimeter sample cell. In some examples, the percent transmission under these same conditions is at least 30 percent, at least 40 percent and can be up to 80 percent or higher, up to 70 percent, or up to 60 percent. The reaction mixture is translucent and not opaque. In some embodiments, the cured gel compositions are translucent.

The transmission of the ultraviolet/visible radiation should be sufficiently high to form a gel composition that is uniform. The transmission should be sufficient to allow polymerization to occur uniformly throughout the mold cavity. That is, percent cure should be uniform or fairly uniform throughout the gel composition formed within the mold cavity. The depth of cure is often at least 5 millimeters, at least 10 millimeters, or at least 20 millimeters when cured for 12 minutes as described below in the Example section within a chamber having eight UV/visible lamps and using 0.2 weight percent photoinitiator based on the weight of the inorganic oxides.

The reaction mixture (casting sol) typically has a viscosity that is sufficiently low so that it can effectively fill small, complex features of a mold cavity. In many embodiments, the reaction mixtures have viscosities that are Newtonian or nearly Newtonian. That is, the viscosity is independent of shear rate or has only a slight dependence on shear rate. The viscosity can vary depending on the percent solids of the reaction mixture, the size of the zirconia-based particles, the composition of the solvent medium, the presence or absence of optional non-polymerizable surface modification agents, and the composition of the polymerizable material. In some embodiments, the viscosity is at least 2 centipoises, at least 5 centipoises, at least 10 centipoises, at least 25 centipoises, at least 50 centipoises, at least 100 centipoises, at least 150 centipoises, or at least 200 centipoises. The viscosity can be up to 500 centipoises, up to 300 centipoises, up to 200 centipoises, up to 100 centipoises, up to 50 centipoises, up to 30 centipoises, or up to 10 centipoises. For example, the viscosity can be in a range of 2 to 500 centipoises, 2 to 200 centipoises, 2 to 100 centipoises, 2 to 50 centipoises, 2 to 30 centipoises, 2 to 20 centipoises, or 2 to 10 centipoises.

The combination of low viscosity and small particle size of the zirconia-based particles advantageously allows the reaction mixture (casting sol) to be filtered before polymerization. The reaction mixture is often filtered prior to placement within the mold cavity. Filtering can be beneficial for removal of debris and impurities that can negatively impact the properties of the gel composition and properties of the sintered article such as optical transmission and strength. Suitable filters often retain material having a size greater than 0.22 micrometers, greater than 0.45 micrometers, greater than 1 micrometer, greater than 2 micrometers, or greater than 5 micrometers. Traditional ceramic molding compositions cannot be easily filtered due to particle size and/or viscosity.

In some embodiments, the mold has multiple mold cavities or multiple molds with a single mold cavity can be arranged to form a belt, sheet, continuous web or die that can be used in a continuous process of preparing shaped gel articles.

The mold can be constructed of any material commonly used for a mold. That is, the mold can be fabricated from a metallic material including an alloy, ceramic material, glass, quartz, or polymeric material. Suitable metallic materials include, but are not limited to nickel, titanium, chromium, iron, carbon steel, and stainless steel. Suitable polymeric materials include, but are not limited to, a silicone, polyester, polycarbonate, poly(ether sulfone), poly(methyl methacrylate), polyurethane, polyvinylchloride, polystyrene, polypropylene, or polyethylene. In some cases, the entire mold is constructed of one or more polymeric materials. In other cases, only the surfaces of the mold that are designed to contact the casting sol, such as the surface of the one or more mold cavities, are constructed of one or more polymeric materials. For example, when the mold is made from metal, glass, ceramic, or the like, one or more surfaces of the mold can optionally have a coating of a polymeric material.

The mold having one or more mold cavities can be replicated from a master tool. The master tool can have a pattern that is the inverse of the pattern that is on the working mold in that the master tool can have protrusions that correspond to the cavities on the mold. The master tool can be made of metal, such as nickel or an alloy thereof. To make the mold, a polymeric sheet can be heated and placed next to the master tool. The polymeric sheet can then be pushed against the master tool to emboss the polymeric sheet, thereby forming a working mold. It is also possible to extrude or cast one or more polymeric materials onto a master tool to prepare the working mold. Many other types of mold materials, such as metal, can be embossed by a master tool in a similar manner. Disclosures related to forming working molds from master tools include U.S. Pat. No. 5,125,917 (Pieper), U.S. Pat. No. 5,435,816 (Spurgeon), U.S. Pat. No. 5,672,097 (Hoopman), U.S. Pat. No. 5,946,991 (Hoopman), U.S. Pat. No. 5,975,987 (Hoopman), and U.S. Pat. No. 6,129,540 (Hoopman).

The mold cavity can have any desired three-dimensional shape. Some molds have a plurality of uniform mold cavities with the same size and shape. The mold cavity can have a surface that is smooth (i.e., lacking features) or can have features of any desired shape and size. The resulting shaped gel articles can replicate the features of the mold cavity even if the dimensions are quite small. This is possible because of the relatively low viscosity of the reaction mixture (casting sol) and the use of zirconia-based particles having an average particle size no greater than 100 nanometers. For example, the shaped gel article can replicate features of the mold cavity that have a dimension less than 100 micrometers, less than 50 micrometers, less than 20 micrometers, less than 10 micrometers, less than 5 micrometers, or less than 1 micrometer.

The mold cavity has at least one surface that allows transmission of ultraviolet and/or visible radiation to initiate the polymerization of the reaction mixture within the mold cavity. In some embodiments, this surface is selected to be constructed of a material that will transmit at least 50 percent, at least 60 percent, at least 70 percent, at least 80 percent, at least 90 percent, or at least 95 percent of the incident ultraviolet and/or visible radiation. Higher transmission may be needed as the thickness of the molded part increases. The surface is often glass or a polymeric material such as polyethylene terephthalate, poly(methyl methacrylate), or polycarbonate.

In some cases, the mold cavity is free of a release agent. This can be beneficial because it can help ensure that the contents of the mold stick to the mold walls and maintain the shape of the mold cavity. In other cases, release agents can be applied to the surfaces of the mold cavity to ensure clean release of the shaped gel article from the mold.

The mold cavity, whether coated with mold release agent or not, can be filled with the reaction mixture (casting sol). The reaction mixture can be placed into the mold cavity by any suitable methods. Examples of suitable methods include pumping through a hose, using a knife roll coater, or using a die such as a vacuum slot die. A scraper or leveler bar can be used to force the reaction mixture into the one or more cavities, and to remove any of the reaction mixture that does not fit into the mold cavity. Any portion of reaction mixture that does not fit into the one or more mold cavities can be recycled and used again later, if desired. In some embodiments, it may be desirable to form a shaped gel article that is formed from multiple adjacent mold cavities. That is, it may be desirable to allow the reaction mixture to cover a region between two mold cavities to form a desired shaped gel article.

Because of its low viscosity, the casting sol can effectively fill small crevices or small features in the mold cavity. These small crevices or features can be filled even at low pressures. The mold cavity can have a smooth surface or can have a complex surface with one or more features. The features can have any desired shape, size, regularity, and complexity. The casting sol can typically flow effectively to cover the surface of the mold cavity regardless of the complexity of the shape of the surface. The casting sol is usually in contact with all surfaces of the mold cavity.

Polymerization of the reaction mixture occurs upon exposure to ultraviolet and/or visible radiation and results in the formation of a gel composition, which is a polymerized (cured) product of the reaction mixture. The gel composition is a shaped gel article having a shape that is the same as the mold (e.g., the mold cavity). The gel composition is a solid or semi-solid matrix with liquid entrapped therein. The solvent medium in the gel composition is mainly the organic solvent having a boiling point equal to at least 150° C.

Due to the homogeneous nature of the casting sol and the use of ultraviolet/visible radiation to cure the polymeric material, the resulting gel composition tends to have a homogeneous structure. This homogeneous structure advantageously leads to isotropic shrinkage during further processing to form a sintered article.

The reaction mixture (casting sol) typically cures (i.e., polymerizes) with little or no shrinkage. This is beneficial for maintaining the fidelity of the gel composition relative to the mold. Without being bound by theory, it is believed that the low shrinkage may be contributable to the combination of high solvent medium concentrations in the gel compositions as well as the bonding of the zirconia-based particles together through the polymerized surface modification agent that is attached to the surface of the particles.

Preferably, the gelation process (i.e., the process of forming the gel composition) allows the formation of shaped gel articles of any desired size that can then be processed without inducing crack formation. For example, preferably the gelation process leads to a shaped gel article having a structure that will not collapse when removed from the mold. Preferably, the shaped gel article is stable and sufficiently strong to withstand drying and sintering.

### Formation of Xerogel or Aerogel

After polymerization, the shaped gel article is removed from the mold cavity and the shaped gel article is treated to remove the organic solvent having a boiling point equal to at least 150° C. and any other organic solvents or water that may be present. This can be referred to as drying the gel composition or the shaped gel article regardless of the method used to remove the organic solvent.

In some embodiments, removal of the organic solvent occurs by drying the shaped gel article at room temperature (e.g., 20° C. to 25° C.) or at an elevated temperature. Any desired drying temperature up to 200° C. can be used. If the drying temperature is higher, the rate of organic solvent removal may be too rapid and cracking can result. The temperature is often no greater than 175° C., no greater than 150° C., no greater than 125° C., or no greater than 100° C. The temperature for drying is usually at least 25° C., at least 50° C., or at least 75° C. A xerogel results from this process of organic solvent removal.

Forming a xerogel can be used for drying shaped gel articles with any dimensions but is most frequently used for the preparation of relatively small sintered articles. As the gel composition dries either at room temperature or at elevated temperatures, the density of the structure increases. Capillary forces pull the structure together resulting in some linear shrinkage such as up to about 25 percent, up to 20 percent or up to 15 percent. The shrinkage is typically dependent on the amount of inorganic oxide present and the overall composition. The linear shrinkage is often in a range of 5 to 25 percent, 10 to 25 percent, or 5 to 15 percent. Because the drying typically occurs most rapidly at the outer surfaces, density gradients are often established throughout the structure. Density gradients can lead to the formation of cracks. The likelihood of crack formation increases with the size and the complexity of the shaped gel article and with the complexity of the structure. In some embodiments, xerogels are used to prepare sintered bodies having a longest dimension no greater than about 1 centimeter.

In some embodiments, the xerogels contain some residual organic solvent with a boiling point equal to at least 150° C. The residual solvent can be up to 6 weight percent based on the total weight of the aerogel. For example, the xerogel can contain up to 5 weight percent, up to 4 weight percent, up to 3 weight percent, up to 2 weight percent, or up to 1 weight percent organic solvent having a boiling point equal to at least 150° C.

If the shaped gel article has fine features that can be easily broken or cracked, it is often preferable to form an aerogel intermediate rather than a xerogel. A shaped gel article of any size and complexity can be dried to an aerogel. An aerogel is formed by drying the shaped gel article under supercritical conditions. A supercritical fluid, such as supercritical carbon dioxide, can be contacted with the shaped gel article in order to remove solvents that are soluble in or miscible with the supercritical fluid. The organic solvent having a boiling point equal to at least 150° C. can be removed by supercritical carbon dioxide. There is no capillary effect for this type of drying and the linear shrinkage is often in a range of 0 to 25 percent, 0 to 20 percent, 0 to 15 percent, 5 to 15 percent, or 0 to 10 linear percent. The volume shrinkage is often in a range of 0 to 50 percent, 0 to 40 percent, 0 to 35 percent, 0 to 30 percent, 0 to 25 percent, 10 to 40 percent, or 15 to 40 percent. Both the linear and volume shrinkage are dependent on the percent inorganic oxide present in the structures. The density typically remains uniform throughout the structure. Supercritical extraction is discussed in detail in van Bommel et al., J. Materials Sci., 29, 943-948 (1994), Francis et al., J. Phys. Chem., 58, 1099-1114 (1954) and McHugh et al., Supercritical Fluid Extraction: Principles and Practice, Butterworth-Heinemann, Stoneham, M A, 1986.

The use of the organic solvent having a boiling point equal to at least 150° C. advantageously eliminates the need to soak the shaped gel article in a solvent such as alcohol (e.g., ethanol) to replace water prior to supercritical extraction. This replacement is needed to provide a liquid that is soluble with (can be extracted by) the supercritical fluid. The soaking step often results in the formation of a rough surface on the shaped gel article. The rough surface created from the soaking step may result from residue deposition (e.g., organic residue) during the soaking step. Without the soaking step, the shaped gel article can better retain the original glossy surface it had upon removal from the mold cavity.

Supercritical extraction can remove all or most of the organic solvent having a boiling point equal to at least 150° C. The removal of the organic solvent results in the formation of pores within the dried structure. Preferably, the pores are sufficiently large to allow gases from the decomposition products of the polymeric material to escape without cracking the structure when the dried structure is further heated to burnout the organic material and to form a sintered article.

In some embodiments, the aerogels contain some residual organic solvent with a boiling point equal to at least 150° C. The residual solvent can be up to 6 weight percent based on the total weight of the aerogel. For example, the aerogel can contain up to 5 weight percent, up to 4 weight percent, up to 3 weight percent, up to 2 weight percent, or up to 1 weight percent organic solvent having a boiling point equal to at least 150° C.

In some embodiments, aerogels have a surface area (i.e., a BET specific surface area) in a range of 50 m²/gram to 400 m²/gram. For example, the surface area is at least 75 m²/gram, at least 100 m²/gram, least 125 m²/gram, at least 150 m²/gram, or at least 175 m²/gram. The surface area can be up to 350 m²/gram, up to 300 m²/gram, up to 275 m²/gram, up to 250 m²/gram, up to 225 m²/gram, or up to 200 m²/gram.

The volume percent inorganic oxide in the aerogel is often in a range of 3 to 30 volume percent. For example, the volume percent of the inorganic oxide is often at least 4 volume percent or at least 5 volume percent. Aerogels having a lower volume percent inorganic oxide tend to be quite fragile and may crack during supercritical extraction or subsequent processing. Additionally, if there is too much polymeric material present, the pressure during subsequent heating may be unacceptably high resulting in the formation of cracks. Aerogels with more than 30 volume percent inorganic oxide content tend to crack during the calcination process when the polymeric material decomposes and vaporizes. It may be more difficult for the decomposition products to escape from the denser structures. The volume percent inorganic oxide is often up to 25 volume percent, up to 20 volume percent, up to 15 volume percent, or up to 10 volume percent. The volume percent is often in a range of 3 to 25 volume percent, 3 to 20 volume percent, 3 to 15 volume percent, 4 to 20 volume percent, or 5 to 20 volume percent.

### Organic Burnout and Pre-Sintering

After removal of the solvent medium, the resulting xerogel or aerogel is heated to remove the polymeric material or any other organic material that may be present and to build strength through densification. The temperature is often raised as high as 1000° C. or 1100° C. during this process. The rate of temperature increase is usually carefully controlled so that the pressure resulting from the decomposition and vaporization of the organic material does not result in pressures within the structures sufficient to generate cracks.

The rate of temperature increase can be constant or can be varied over time. The temperature can be increased to a certain temperature, held at that temperature for a period of time, and then increased further at the same rate or at a different rate. This process can be repeated multiple times, if desired. The temperature is gradually increased to about 1000° C. or to about 1100° C. In some embodiments, the temperature is first increased from about 20° C. to about 200° C. at a moderate rate such as in a range of 10° C./hour to 30° C./hour. This is followed by increasing the temperature to about 400° C., to about 500° C., or to about 600° C. relatively slowly (e.g., at a rate of 1° C./hour to less than 10° C./hour). This slow heating rate facilitates vaporization of the organic material without cracking the structure. After the majority of the organic material has been removed, the temperature can then be rapidly increased to about 1000° C. or to about 1100° C. such as at a rate greater than 50° C./hour (e.g., 50° C./hour to 100° C./hour). The temperature can be held at any temperature for up to 5 minutes, up to 10 minutes, up to 20 minutes, up to 30 minutes, up to 60 minutes, or up to 120 minutes or even longer.

Thermogravimetric analysis and dilatometry can be used to determine the appropriate rate of heating. These techniques track the weight loss and shrinkage that occur at different heating rates. The heating rates in different temperature ranges can be adjusted to maintain a slow and near constant rate of weight loss and shrinkage until the organic material is removed. Careful control of organic removal facilitates the formation of sintered articles with minimal or no cracking.

The article is often cooled to room temperature after organic burnout. The cooled article optionally can be soaked in a basic solution such as an aqueous solution of ammonium hydroxide. Soaking can be effective to remove undesirable ionic species such as sulfate ions because of the porous nature of the articles at this stage of the process. Sulfate ions can ion exchange with hydroxyl ions. If sulfate ions are not removed, they can generate small pores in the sintered articles that tend to reduce the translucency and/or the strength.

More specifically, the ion exchange process often includes soaking the article that has been heated to remove organic material in an aqueous solution of 1 N ammonium hydroxide. This soaking step is often for at least 8 hours, at least 16 hours, or at least 24 hours. After soaking, the article is removed from the ammonium hydroxide solution and washed thoroughly with water. The article can be soaked in water for any desired period of time such as at least 30 minutes, at least 1 hour, at least 2 hours, or at least 4 hours. The soaking in water can be repeated several times, if desired, by replacing the water with fresh water.

After soaking, the article is typically dried in an oven to remove the water. For example, the article can be dried by heating in an oven set at a temperature equal to at least 80° C., at least 90° C., or at least 100° C. For example, the temperature can be in a range of 80° C. to 150° C., 90° C. to 150° C., or 90° C. to 125° C. for at least 30 minutes, at least 60 minutes, or at least 120 minutes.

### Sintering

After organic burnout and optional soaking in an aqueous solution of ammonium hydroxide, the dried article is sintered. Sintering typically occurs at a temperature greater than 1100° C. such as, for example, at least 1200° C., at least 1250° C., at least 1300° C., or at least 1320° C. The rate of heating can typically be quite rapid such as at least 100° C./hour, at least 200° C./hour, at least 400° C./hour, or at least 600° C./hour. The temperature can be held for any desired time to produce sintered articles having the desired density. In some embodiments, the temperature is held for at least 1 hour, at least 2 hours, or at least 4 hours. The temperature can be held for 24 hours or even longer, if desired.

The density of the dried article increases during the sintering step and the porosity is substantially reduced. If the sintered article has no pores (i.e., voids), it is considered to have the maximum density possible for that material. This maximum density is referred to as the “theoretical density”. If pores are present in the sintered article, the density is less than the theoretical density. The percentage of the theoretical density can be determined from electron micrographs of a cross-section of the sintered article. The percent of the area of the sintered article in the electron micrograph that is attributable to pores can be calculated. Stated differently, the percent of the theoretical density can be calculated by subtracting the percent voids from 100 percent. That is, if 1 percent of the area of the electron micrograph of the sintered article is attributable to pores, the sintered article is considered to have a density equal to 99 percent. The density can also be determined by the Archimedes method.

In many embodiments, the sintered article has a density that is at least 99 percent of the theoretical value. For example, the density can be at least 99.2 percent, at least 99.5 percent, at least 99.6 percent, at least 99.7 percent, at least 99.8 percent, at least 99.9 percent, or at least 99.95 percent or even at least 99.99 percent of the theoretical density. As the density approaches the theoretical density, the translucency of the sintered articles tends to improve. Sintered articles having a density that is at least 99 percent of the theoretical density often appears translucent to the human eye.

The sintered article contains crystalline zirconia-based material. The crystalline zirconia-based material is often predominately cubic and/or tetragonal. Tetragonal materials can undergo transformational toughening when fractured. That is, a portion of the tetragonal phase material can be transformed to monoclinic phase material in the region of the fracture. The monoclinic phase material tends to occupy a larger volume than the tetragonal phase and tends to arrest the propagation of the fracture.

In many embodiments, at least 80 percent of the zirconia-based material in the sintered article as initially prepared is present in the cubic and/or tetragonal crystalline phase. That is, as initially prepared, at least 80 percent, at least 85 percent, at least 90 percent, at least 95 percent, at least 98 percent, at least 99 percent, or at least 99.5 percent of the zirconia-based material is cubic and/or tetragonal phase. The remainder of the zirconia-based material is typically monoclinic. Stated in terms of the amount of monoclinic phase, up to 20 percent of the zirconia-based material is monoclinic.

The zirconia-based material in the sintered article is usually 80 to 100 percent cubic and/or tetragonal and 0 to 20 percent monoclinic, 85 to 100 percent cubic and/or tetragonal and 0 to 15 percent monoclinic, 90 to 100 percent cubic and/or tetragonal and 0 to 10 percent monoclinic, or 95 to 100 percent cubic and/or tetragonal and 0 to 5 percent monoclinic.

The average grain size is often in a range of 75 nanometers to 400 nanometers or in a range of 100 nanometers to 400 nanometers. The grain size is typically no greater than 400 nanometers, no greater than 350 nanometers, no greater than 300 nanometers, no greater than 250 nanometers, no greater than 200 nanometers, or no greater than 150 nanometers. This grain size contributes to the high strength of the sintered articles.

The sintered materials can have, for example, an average biaxial flexural strength of at least 300 MPa. For example, the average biaxial flexural strength can be at least 400 MPa, at least 500 MPa, at least 750 MPa, at least 1000 MPa, or even at least 1300 MPa.

Sintered materials can have a total transmittance of at least 65% at a thickness of one millimeter.

The shape of the sintered article is typically identical to that of the shaped gel article. Compared to the shaped gel article, the sintered article has undergone isotropic size reduction (i.e., isotropic shrinkage). That is, the extent of shrinkage in one direction is within 5 percent, within 2 percent, within 1 percent, or within 0.5 percent of the shrinkage in the other two directions. Stated differently, a net shaped sintered article can be prepared from the shaped gel articles. The shaped gel articles can have complex features that can be retained in the sintered article but with smaller dimensions based on the extent of isotropic shrinkage. That is, net shaped sintered articles can be formed from the shaped gel articles.

The amount of isotropic linear shrinkage between the shaped gel article and the sintered article is often in a range of 40 to 70 percent or in a range of 45 to 55 percent. The amount of isotropic volume shrinkage is often in a range of 80 to 97 percent, 80 to 95 percent, or 85 to 95 percent. These large amounts of isotropic shrinkage result from the relatively low amount of zirconia-based particles (3 to 30 volume percent) included in the reaction mixture used to form the gel composition (shaped gel article). Conventional teaching has been that high volume fractions of the inorganic oxides are needed to obtain fully dense sintered articles. Surprisingly, gel compositions can be obtained from casting sols with a relatively low amount of the zirconia-based particles that are sufficiently strong to be removed from molds (even molds having intricate and complex shapes and surfaces), dried, heated to burnout organic matter, and sintered without cracking. It is also surprising that the shape of the sintered articles can match that of the shaped gel article and the mold cavity so well in spite of the large percent shrinkage. The large percent shrinkage can be an advantage for some applications. For example, it allows the manufacture of smaller parts than can be obtained using many other ceramic molding processes.

The isotropic shrinkage tends to lead to the formation of sintered articles that are typically free of cracks and that have a uniform density throughout. Any cracks that form are often associated with cracks that result from the removal of the shaped gel article from the mold cavity rather than cracks that form during formation of the aerogel or xerogel, during burnout of the organic material, or during the sintering process. In some embodiments, particularly for larger articles or for articles with complex features, it may be preferable to form an aerogel rather than a xerogel intermediate.

Sintered articles with any desired size and shape can be prepared. The longest dimension can be up to 1 centimeter, up to 2 centimeters, up to 5 centimeters, or up to 10 centimeters or even longer. The longest dimension can be at least 1 centimeter, at least 2 centimeters, at least 5 centimeters, at least 10 centimeters, at least 20 centimeters, at least 50 centimeters, or at least 100 centimeters.

The sintered articles can have smooth surfaces or surfaces that include various features. The features can have any desired shape, depth, width, length, and complexity. For example, the features can have a longest dimension less than 500 micrometers, less than 100 micrometers, less than 50 micrometers, less than 25 micrometers, less than 10 micrometers, less than 5 micrometers, or less than 1 micrometer. Stated differently, sintered articles having a complex surface or multiple complex surfaces can be formed from a shaped gel article that has undergone isotropic shrinkage.

The sintered articles are net shaped articles formed from the shaped gel articles, which are formed within a mold cavity. The sintered article can often be used without any further milling or processing because they so closely mimic the shape of the shaped gel article, but with smaller dimensions in the amount of isotropic shrinkage, which has the same shape as the mold cavity used in its formation.

The sintered articles are typically strong and translucent. These properties are the result, for example, of starting with a zirconia-containing sol effluent that contains zirconia-based nanoparticles that are non-associated. These properties are also the result of preparing a gel composition that is homogenous. That is, the density and composition of the gel composition are uniform throughout the shaped gel article. These properties are also the result of preparing a dried gel shaped article (either a xerogel or aerogel) that has small uniform pores throughout. These pores are removed by sintering to form the sintered article. The sintered articles have a high theoretical density while having minimal grain size. The small grain size leads to high strength and high translucency. Various inorganic oxides such as yttrium oxide, for example, are often added to adjust the translucency by adjusting the amount of cubic and tetragonal phases in the sintered article.

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

Exemplary embodiments of the present disclosure may take on various modifications and alterations without departing from the spirit and scope of the present disclosure. Accordingly, it is to be understood that the embodiments of the present disclosure are not to be limited to the following described exemplary embodiments, but is to be controlled by the limitations set forth in the claims and any equivalents thereof.

### Listing of Exemplary Embodiments

Exemplary embodiments are listed below. It is to be understood that any one of embodiments 1-11 and 12-21 can be combined.

Embodiment 1 is a haptic device comprising:
a shaped zirconia ceramic plate including a plate body and a working surface thereof, and
a piezoelectric actuator attached to the shaped zirconia ceramic plate, configured to generate a standing wave on the working surface of the shaped zirconia ceramic plate at an ultrasonic frequency greater than 20 kHz.

Embodiment 2 is the haptic device of embodiment 1, wherein the shaped zirconia ceramic plate further includes one or more mounting features formed on the plate body as a one-piece structure.

Embodiment 3 is the haptic device of embodiment 2, wherein the one or more mounting features include at least one of one or more slots, one or more grooves, one or more tabs, one or more holes, one or more bosses, or one or more sockets.

Embodiment 4 is the haptic device of any one of embodiments 1-3, wherein the shaped zirconia ceramic plate is a product of drying and sintering a shaped gel article.

Embodiment 5 is the haptic device of embodiment 4, wherein the shaped gel article comprises a polymerized product of a reaction mixture, wherein the reaction mixture is positioned within a mold cavity during polymerization and wherein the shaped gel article retains both a size and shape identical to the mold cavity (except in a region where the mold cavity was overfilled) when removed from the mold cavity, the reaction mixture comprising:
a. 20 to 60 weight percent zirconia-based particles based on a total weight of the reaction mixture, the zirconia-based particles having an average particle size no greater than 100 nanometers and comprising at least 70 mole percent ZrO₂;
b. 30 to 75 weight percent of a solvent medium based on the total weight of the reaction mixture, the solvent medium comprising at least 60 percent of an organic solvent having a boiling point equal to at least 150° C.;
c. 2 to 30 weight percent polymerizable material based on a total weight of the reaction mixture, the polymerizable material comprising (1) a first surface modification agent having a free radical polymerizable group; and
d. a photoinitiator for a free radical polymerization reaction.

Embodiment 6 is the haptic device of any one of embodiments 1-5, wherein the shaped zirconia ceramic plate comprises at least 70 mole percent zirconia-based material, and wherein at least 80 weight percent of the zirconia-based material have a cubic crystalline structure, a tetragonal crystalline structure, or a combination thereof.

Embodiment 7 is the haptic device of embodiment 6, wherein the shaped zirconia ceramic plate has a density that is at least 99 percent of a theoretical density of crystalline zirconia in a cubic or tetragonal phase, the theoretical density being the maximum density of crystalline zirconia in the cubic or tetragonal phase with no pores.

Embodiment 8 is the haptic device of any one of embodiments 1-7, wherein the plate body includes at least one of a flat structure, a curved structure, or a contoured structure.

Embodiment 9 is the haptic device of any one of embodiments 1-8, further comprising a display overlaid with the shaped zirconia ceramic plate.

Embodiment 10 is the haptic device of embodiment 9, wherein the display is received by a frame, and the shaped zirconia ceramic plate is mounted, via one or more mounting features thereof, on the frame.

Embodiment 11 is the haptic device of any one of embodiments 1-10, further comprising a processor, configured to control a frequency and an amplitude of the standing wave generated by the piezoelectric actuator based on detection of a location of an input unit on the working surface.

Embodiment 12 is a method of making a haptic device, the method comprising:
providing a reaction mixture within a mold cavity, the reaction mixture comprising 20 to 60 weight percent zirconia-based particles based on a total weight of the reaction mixture;
polymerizing the reaction mixture to form a shaped gel plate within the mold cavity and in contact with a surface of the mold cavity;
removing the shaped gel plate from the mold cavity, wherein the shaped gel plate retains a size and shape identical to the mold cavity;
forming a dried shaped gel plate by removing the solvent medium;
heating the dried shaped gel plate to form a shaped zirconia ceramic plate; and
providing a piezoelectric actuator attached to the shaped zirconia ceramic plate, configured to generate a standing wave on the working surface of the shaped zirconia ceramic plate at an ultrasonic frequency greater than 20 kHz.

Embodiment 13 is the method of embodiment 12, wherein the zirconia-based particles have an average particle size no greater than 100 nanometers and comprise at least 70 mole percent ZrO₂.

Embodiment 14 is the method of embodiment 13, wherein the zirconia-based particles are crystalline, and at least 80 weight percent of the zirconia-based particles have a cubic structure, tetragonal structure, or a combination thereof.

Embodiment 15 is the method of embodiment 13 or 14, wherein the zirconia-based particles comprise 80 to 99 mole percent zirconium oxide, 1 to 20 mole percent yttrium oxide, and 0 to 5 mole percent lanthanum oxide.

Embodiment 16 is the method of any one of embodiments 12-15, wherein the reaction mixture further comprises:
30 to 75 weight percent of a solvent medium based on the total weight of the reaction mixture, the solvent medium comprising at least 60 percent of an organic solvent having a boiling point equal to at least 150° C.;
2 to 30 weight percent polymerizable material based on the total weight of the reaction mixture, the polymerizable material comprising (1) a first surface modification agent having a free radical polymerizable group; and
a photoinitiator for a free radical polymerization reaction.

Embodiment 17 is the method of any one of embodiments 12-16, wherein the shaped zirconia ceramic plate comprises at least 70 mole percent zirconia-based material, and wherein at least 80 weight percent of the zirconia-based material have a cubic crystalline structure, a tetragonal crystalline structure, or a combination thereof.

Embodiment 18 is the method of any one of embodiments 12-17, wherein the shaped gel plate includes a plate body and one or more mounting features formed on the plate body when in contact with the surface of the mold cavity.

Embodiment 19 is the method of any one of embodiments 12-18, further comprising removing the shaped gel plate from the mold cavity, wherein the shaped gel article retains a size and shape identical to the mold cavity except in regions where the mold cavity was overfilled.

Embodiment 20 is the method of any one of embodiments 12-19, further comprising providing a display overlaid with the shaped zirconia ceramic plate.

Embodiment 21 is the method of embodiment 20, further comprising attaching, via mounting features thereof, the shaped zirconia ceramic plate, to the frame of the display.

The operation of the present disclosure will be further described with regard to the following detailed examples. These examples are offered to further illustrate the various specific and preferred embodiments and techniques. It should be understood, however, that many variations and modifications may be made while remaining within the scope of the present disclosure.

### Examples

These Examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

### Materials

TABLE 1

| Material or | |
|---|---|
| abbreviation | Description |
| Sol-1a | Sol-1a, a zirconia-based sol prepared and processed in the manner |
| | described for Sol-S2 in the Examples Section of U.S. Patent |
| | Application Publication US20180044245A1. |
| Diethylene glycol | Diethylene glycol monoethyl ether obtained from Alfa Aesar (Ward |
| monoethyl ether | Hill, MA, USA). |
| MEEAA | 2-[2-(2-Methoxyethoxy)ethoxy]acetic acid obtained from Sigma- |
| | Aldrich (St. Louis, MO, USA). |
| Acrylic acid | Acrylic acid obtained from Alfa Aesar (Ward Hill, MA, USA). |
| HEA | Hydroxyethyl acrylate obtained from Alfa Aesar (Ward Hill, MA, |
| | USA). |
| Octyl acrylate | Octyl acrylate prepared as described in Example 4 of U.S. Pat. No. |
| | 9,908,837. |
| “SR351 H” | Trimethylolpropane triacrylate obtained from Sartomer USA (Exton, |
| | PA, USA) under the trade designation “SR351 H”. |
| “CN975” | Hexafunctional urethane acrylate obtained from Sartomer USA |
| | (Exton, PA, USA) under the trade designation “CN975”. |
| “OMNIRAD 819” | UV/Visible photoinitiator obtained from IGM Resins (Waalwijk, The |
| | Netherlands) under the trade designation “OMNIRAD 819”. |
| DPIC1 | Diphenyliodonium chloride obtained from Alfa Aesar (Ward Hill, |
| | MA, USA). |
| CPQ | Camphorquinone obtained from Alfa Aesar (Ward Hill, MA, USA). |
| EDMAB | Ethyl 4-(dimethylamino)benzoate obtained from Sigma-Aldrich (St. |
| | Louis, MO, USA). |

### Casting Sol Preparation—CS1

Sol-1a had a composition of ZrO₂ (97.7 mole %)/Y₂O₃ (2.3 mole %) in terms of inorganic oxides and was prepared and processed as described for Sol-S2 in the Examples Section of U.S. Patent Application Publication US20180044245A1.

A diethylene glycol monoethyl ether-based sol, Sol-1b, was produced by adding 2-[2-(2-methoxyethoxy)ethoxy]acetic acid (MEEAA) (3.56 weight % with respect to the grams of oxide in the sol) and the appropriate amount of diethylene glycol monoethyl ether (adjusted to the intended final oxide concentration in the sol, e.g, 60 weight %) to a portion of Sol-1a, and concentrating the sol via rotary evaporation. The resulting sol was 60.14 weight % oxide and 9.28 weight % acetic acid.

To prepare casting sol CS1, a portion of Sol-1b (1844.05 grams) was charged to a 2-liter bottle and combined with diethylene glycol monoethyl ether (56.48 grams), acrylic acid (119.87 grams), hydroxyethyl acrylate (HEA) (22.75 grams), octyl acrylate (11.33 grams), trimethylolpropane triacrylate (“SR351 H”) (200.40 grams), and a hexafunctional urethane acrylate (“CN975”) (100.00 grams). Diphenyliodonium chloride (DPICl) (0.99 gram) was charged to the bottle and dissolved in the sol. OMNIRAD 819 (11.09 grams), camphorquinone (CPQ) (3.55 grams), and ethyl 4-(dimethylamino)benzoate (EDMAB) (17.74 grams) were dissolved in diethylene glycol monoethyl ether (407.62 grams) and added to the bottle. The resulting casting sol was passed through a 1-micron filter.

### Gel Body Preparation

A gel body was made by charging casting sol CS1 to a mold cavity in a manner similar to that described in the Detailed Description Section of U.S. Patent Application Publication US20180044245A1. The mold cavity was formed by clamping a frame under the tradename Delrin with an (184.15 mm×116.23 mm×1.20 mm) open area between a P20 stainless steel plate and an acrylic plate with a protective film on the mold cavity side. The casting sol, CS1, charged to the mold cavity was then polymerized to form the gel body using a 450 nm LED array at approximately 0.4 W/cm2 as measured using a Thorlabs model PM100A—Compact Power Meter Console, Mechanical Analog & Graphical LC Display (SN:P1002769) with a detector model number S12C, 400 to 1100 nm, 500 mW (S/N:17062804) for 90 seconds.

### Aerogel Preparation

The gel body was dried to form an aerogel using super critical CO₂ extraction in the manner described in the Examples Section of U.S. Patent Application Publication US20180044245A1.

### Pre-Sintered Body Preparation

The dried aerogel body was placed on a bed of zirconia beads in an alumina crucible. The crucible was covered with an alumina crucible and then fired in air according to the following schedule:
1—Heat from 20° C. to 220° C. at 18° C./hour rate,
2—Heat from 220° C. to 244° C. at 1° C./hour rate,
3—Heat from 244° C. to 400° C. at 6° C./hour rate,
4—Heat from 400° C. to 1020° C. at 60° C./hour rate,
5—Cool from 1020° C. to 20° C. at 120° C./hour rate.

### Sintered Body Preparation

The pre-sintered body was placed on a bed of zirconia beads in an alumina crucible. The crucible was covered with an alumina crucible and the sample was then sintered in air according to the following schedule:
1—Heat from 25° C. to 1020° C. at 500° C./hour rate,
2—Heat from 1020° C. to 1320° C. at 120° C./hour rate,
3—Hold at 1320° C. for 2 hours,
4—Cool down from 1320° C. to 25° C. at 500° C./hour rate.

After sintering the part was not flat so it was sintered a second time using the above schedule, but it was sandwiched between two alumina plates and weighted with 977 grams to promote creep. This resulted in flattening of the part.

### Casting Sol Preparation—CS2

Sol-1a had a composition of ZrO₂ (97.7 mole %)/Y₂O₃ (2.3 mole %) in terms of inorganic oxides and was prepared and processed as described for Sol-S2 in the Examples Section of U.S. Patent Application Publication US20180044245A1.

A diethylene glycol monoethyl ether-based sol, Sol-1c, was produced by adding 2-[2-(2-methoxyethoxy)ethoxy]acetic acid (MEEAA) (3.56 weight % with respect to the grams of oxide in the sol) and the appropriate amount of diethylene glycol monoethyl ether (adjusted to the intended final oxide concentration in the sol, e.g, 60 weight %) to a portion of Sol-1a, and concentrating the sol via rotary evaporation. The resulting Sol-1c was 61.50 weight % oxide and 8.11 weight % acetic acid.

To prepare casting sol CS2, a portion of Sol-1c (1238.15 grams) was charged to a 1-liter jar and combined with diethylene glycol monoethyl ether (93.89 grams), 2-[2-(2-methoxyethoxy)ethoxy]acetic acid (MEEAA) (13.57 grams), acrylic acid (82.31 grams), hydroxyethyl acrylate (HEA) (8.20 grams), octyl acrylate (4.08 grams), trimethylolpropane triacrylate (“SR351 H”) (72.24 grams), and a hexafunctional urethane acrylate (“CN975”) (36.05 grams). OMNIRAD 819 (5.48 grams), camphorquinone (CPQ) (1.75 grams), ethyl 4-(dimethylamino)benzoate (EDMAB) (8.77 grams), and diphenyliodonium chloride (DPICl) (0.58 gram) were charged to the jar and dissolved in the sol.

### Gel Body Preparation

A gel body was made by charging casting sol CS2 to a mold cavity in a similar manner as described in the Detailed Description Section of U.S. Patent Application Publication US20180044245A1. The mold cavity was formed by clamping a Delrin™ frame with an (203.2 mm×114.3 mm×3.175 mm) open area between a P20 stainless steel plate and an acrylic plate with protective film on the mold cavity side. The casting sol, CS2, charged to the mold cavity was then polymerized to form the gel body using a 450 nm LED array at approximately 0.4 W/cm2 as measured using a Thorlabs model PM100A—Compact Power Meter Console, Mechanical Analog & Graphical LC Display (SN:P1002769) with a detector model number S12C, 400 to 1100 nm, 500 mW (S/N:17062804) for 30 seconds.

### Aerogel Preparation

The gel body was dried to form an aerogel using super critical CO₂ extraction in manner similar to that described in the Examples Section of U.S. Patent Application Publication US20180044245A1.

### Pre-Sintered Body Preparation

The dried aerogel body was placed on an alumina plate and then fired in air according to the following schedule:
1—Heat from 20° C. to 220° C. at 18° C./hour rate,
2—Heat from 220° C. to 244° C. at 1° C./hour rate,
3—Heat from 244° C. to 400° C. at 6° C./hour rate,
4—Heat from 400° C. to 1020° C. at 60° C./hour rate,
5—Cool from 1020° C. to 20° C. at 120° C./hour rate.

### Sintered Body Preparation

The pre-sintered body was ion exchanged in a manner similar to that described in the Examples Section of U.S. Patent Application Publication US20180044245A1.

The pre-sintered body was then placed on an alumina plate and sintered in air according to the following schedule:
1—Heat from 25° C. to 1020° C. at 500° C./hour rate,
2—Heat from 1020° C. to 1320° C. at 120° C./hour rate,
3—Hold at 1320° C. for 2 hours,
4—Cool down from 1320° C. to 25° C. at 500° C./hour rate.

After sintering the part was not flat so it was sintered a second time using the above schedule, but it was sandwiched between two alumina plates and weighted with 2500 grams to promote creep. This resulted in flattening of the part.

### Example Measurements

Three sintered bodies EX-1, EX-2 and EX-3, measuring 104.1 mm×59.3 mm×1.62 mm thick, 104.0 mm×59.4 mm×1.64 mm thick, and 106.7 mm×59.6 mm×1.63 mm thick, respectively, and 104.9 mm×59.4 mm×1.63 mm thick in mean, were fabricated as described above. The density for each sample was about 6100.0 kg/m³. Haptic resonators were made by attaching a piezoelectric resonator (STEMiNC part number SMPL60W05T21F27R) (Steiner & Martins Inc., Doral, FL USA) measuring 60 mm×5 mm×2 mm thick to the short side of each sintered body with an electrically conductive epoxy (Epo-Tek H20E, Epoxy Technology, Inc., Billerica, MA USA). Positive and negative leads were attached to each terminal of the piezoelectric resonator and terminated with a BNC connector.

Four haptic resonators CE-1, CE-2, CE-3 and CE-4 were made by attaching a piezoelectric resonator (STEMiNC part number SMPL60W05T21F27R) (Steiner & Martins Inc., Doral, FL USA) to four amorphous glass plates, measuring 105.7 mm×60.0 mm×1.70 mm thick. The density for each sample was about 2764.0 kg/m³. The piezoelectric resonators, measuring 60 mm×5 mm×2 mm thick were bonded to the short side of each glass plate with an electrically conductive epoxy (Epo-Tek H20E, Epoxy Technology, Inc., Billerica, MA USA). Positive and negative leads were attached to each terminal of the piezoelectric resonator and terminated with a BNC connector.

Each of the seven haptic resonators above, EX-1, EX-2, EX-3, CE-1, CE-2, CE-3 and CE-4, was coupled to a Trek PZD350A M/S piezoelectric amplifier (Trek Inc., Lockport, NY, USA) via the attached BNC connector. The resonators were driven at the peak resonant frequency between 20 kHz and 40 kHz. A Tektronix PA1000 power analyzer (Tektronix, Inc., Beaverton, OR USA) was used to measure the input power and a Polytec (PV-500) Laser Scanning Vibrometer (Polytec, Inc., Irvine, CA USA) was used to measure the maximum z-axis displacement of the resonator at the resonant frequency at approximately 500 sample points distributed in a triangular grid pattern across the resonator surface. The reported mean z-axis displacement is the mean of these sample points.

Table 2 below shows the maximum z-axis displacement of each of the haptic resonators and the associated input power. The data in Table 2 shows that the ZrO₂ samples requires about half to two thirds the power of the glass samples to get a similar level of Z-axis displacement. This indicates a more efficient power transfer to Z-axis displacement in the ZrO₂ samples as compared to glass samples.

TABLE 2

| | | Driving | Input | Mean z-axis | Z-displacement |
|---|---|---|---|---|---|
| Sample | Material | frequency | Power | displacement* | to power ratio |
| Nos. | Type | (Hz) | (Watts) | (nm) | (m/W) |
| EX-1 | ZrO₂ | 36038 | 0.56 | 458.22 | 8.13E−06 |
| EX-2 | ZrO₂ | 35931 | 0.69 | 342.73 | 4.98E−06 |
| EX-3 | ZrO₂ | 31169 | 0.16 | 454.48 | 2.83E−05 |
| CE-1 | Glass | 34888 | 0.99 | 366.25 | 3.70E−06 |
| CE-2 | Glass | 31413 | 0.94 | 437.76 | 4.65E−06 |
| CE-3 | Glass | 39163 | 0.51 | 380.83 | 7.53E−06 |
| CE-4 | Glass | 34644 | 0.87 | 337.06 | 3.87E−06 |
| ZrO₂ mean | ZrO₂ | 34379 | 0.47 | 418.47 | 8.89E−06 |
| Glass mean | Glass | 35027 | 0.83 | 380.48 | 4.60E−06 |

*Note
that these numbers are the average of the maximum z displacements at a few hundred random points on the working surface (in other words, the dead spots are included in the calculation of average values), so they are not directly comparable to the max displacement at the antinodes of the surface wave.

Reference throughout this specification to “one embodiment,” “certain embodiments,” “one or more embodiments,” or “an embodiment,” whether or not including the term “exemplary” preceding the term “embodiment,” means that a particular feature, structure, material, or characteristic described in connection with the embodiment is included in at least one embodiment of the certain exemplary embodiments of the present disclosure. Thus, the appearances of the phrases such as “in one or more embodiments,” “in certain embodiments,” “in one embodiment,” or “in an embodiment” in various places throughout this specification are not necessarily referring to the same embodiment of the certain exemplary embodiments of the present disclosure. Furthermore, the particular features, structures, materials, or characteristics may be combined in any suitable manner in one or more embodiments.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. In particular, as used herein, the recitation of numerical ranges by endpoints is intended to include all numbers subsumed within that range (e.g., 1 to 5 includes 1, 1.5, 2, 2.75, 3, 3.80, 4, and 5). In addition, all numbers used herein are assumed to be modified by the term “about.” Furthermore, various exemplary embodiments have been described. These and other embodiments are within the scope of the following claims.

What is claimed is:

1. A haptic device comprising:
a shaped zirconia ceramic plate including a plate body and a working surface thereof, and
a piezoelectric actuator attached to the shaped zirconia ceramic plate, configured to generate a standing wave on the working surface of the shaped zirconia ceramic plate at an ultrasonic frequency greater than 20 kHz.

2. The haptic device of claim 1, wherein the shaped zirconia ceramic plate further includes one or more mounting features formed on the plate body as a one-piece structure.

3. The haptic device of claim 2, wherein the one or more mounting features include at least one of one or more slots, one or more grooves, one or more tabs, one or more holes, one or more bosses, or one or more sockets.

4. The haptic device of claim 1, wherein the shaped zirconia ceramic plate is a product of drying and sintering a shaped gel article.

5. The haptic device of claim 4, wherein the shaped gel article comprises a polymerized product of a reaction mixture, wherein the reaction mixture is positioned within a mold cavity during polymerization and wherein the shaped gel article retains both a size and shape identical to the mold cavity (except in a region where the mold cavity was overfilled) when removed from the mold cavity, the reaction mixture comprising:
a. 20 to 60 weight percent zirconia-based particles based on a total weight of the reaction mixture, the zirconia-based particles having an average particle size no greater than 100 nanometers and comprising at least 70 mole percent ZrO₂;
b. 30 to 75 weight percent of a solvent medium based on the total weight of the reaction mixture, the solvent medium comprising at least 60 percent of an organic solvent having a boiling point equal to at least 150° C.;
c. 2 to 30 weight percent polymerizable material based on a total weight of the reaction mixture, the polymerizable material comprising (1) a first surface modification agent having a free radical polymerizable group; and
d. a photoinitiator for a free radical polymerization reaction.

6. The haptic device of claim 1, wherein the shaped zirconia ceramic plate comprises at least 70 mole percent zirconia-based material, and wherein at least 80 weight percent of the zirconia-based material have a cubic crystalline structure, a tetragonal crystalline structure, or a combination thereof.

7. The haptic device of claim 6, wherein the shaped zirconia ceramic plate has a density that is at least 99 percent of a theoretical density of crystalline zirconia in a cubic or tetragonal phase, the theoretical density being the maximum density of crystalline zirconia in the cubic or tetragonal phase with no pores.

8. The haptic device of claim 1, wherein the plate body includes at least one of a flat structure, a curved structure, or a contoured structure.

9. The haptic device of claim 1, further comprising a display overlaid with the shaped zirconia ceramic plate.

10. The haptic device of claim 9, wherein the display is received by a frame, and the shaped zirconia ceramic plate is mounted, via one or more mounting features thereof, on the frame.

11. The haptic device of claim 1, further comprising a processor, configured to control a frequency and an amplitude of the standing wave generated by the piezoelectric actuator based on detection of a location of an input unit on the working surface.

12. A method of making a haptic device, the method comprising:
providing a reaction mixture within a mold cavity, the reaction mixture comprising 20 to 60 weight percent zirconia-based particles based on a total weight of the reaction mixture;
polymerizing the reaction mixture to form a shaped gel plate within the mold cavity and in contact with a surface of the mold cavity;
removing the shaped gel plate from the mold cavity, wherein the shaped gel plate retains a size and shape identical to the mold cavity;
forming a dried shaped gel plate by removing the solvent medium;
heating the dried shaped gel plate to form a shaped zirconia ceramic plate; and
providing a piezoelectric actuator attached to the shaped zirconia ceramic plate, configured to generate a standing wave on the working surface of the shaped zirconia ceramic plate at an ultrasonic frequency greater than 20 kHz.

13. The method of claim 12, wherein the zirconia-based particles have an average particle size no greater than 100 nanometers and comprise at least 70 mole percent ZrO₂.

14. The method of claim 12, wherein the zirconia-based particles are crystalline, and at least 80 weight percent of the zirconia-based particles have a cubic structure, tetragonal structure, or a combination thereof.

15. The method of claim 12, wherein the zirconia-based particles comprise 80 to 99 mole percent zirconium oxide, 1 to 20 mole percent yttrium oxide, and 0 to 5 mole percent lanthanum oxide.

16. The method of claim 11, wherein the reaction mixture further comprises:
30 to 75 weight percent of a solvent medium based on the total weight of the reaction mixture, the solvent medium comprising at least 60 percent of an organic solvent having a boiling point equal to at least 150° C.;
2 to 30 weight percent polymerizable material based on the total weight of the reaction mixture, the polymerizable material comprising (1) a first surface modification agent having a free radical polymerizable group; and
a photoinitiator for a free radical polymerization reaction.

17. The method of claim 12, wherein the shaped zirconia ceramic plate comprises at least 70 mole percent zirconia-based material, and wherein at least 80 weight percent of the zirconia-based material have a cubic crystalline structure, a tetragonal crystalline structure, or a combination thereof.

18. The method of claim 12, wherein the shaped gel plate includes a plate body and one or more mounting features formed on the plate body when in contact with the surface of the mold cavity.

19. The method of claim 12, further comprising removing the shaped gel plate from the mold cavity, wherein the shaped gel article retains a size and shape identical to the mold cavity except in regions where the mold cavity was overfilled.

20. The method of claim 12, further comprising providing a display overlaid with the shaped zirconia ceramic plate, and attaching, via mounting features thereof, the shaped zirconia ceramic plate, to the frame of the display.
